(19) United States
(12) Patent Application Publication
(10) Pub. No.: US 2016/0165630 A1
(43) Pub. Date: Jun. 9, 2016

(54) METHODS AND PROCEDURES FOR SCHEDULING TO SECTOR-EDGE AND NON-SECTOR-EDGE STATION GROUPS

(71) Applicant: INTERDIGITAL PATENT HOLDINGS, INC., Wilmington, DE (US)

(72) Inventors: Oghenekome OTERI, San Diego, CA (US); Hanqing LOU, Syosset, NY (US); Pengfei XIA, San Diego, CA (US); Nirav B. SHAH, San Diego, CA (US); Monisha GHOSH, Chicago, IL (US); Robert L. OLESEN, Huntington, NY (US)

(73) Assignee: INTERDIGITAL PATENT HOLDINGS, INC., Wilmington, DE (US)

(21) Appl. No.: 14/903,900

(22) PCT Filed: Jul. 11, 2014
(86) PCT No.: PCT/US2014/046271

§ 371 Date: Jan. 8, 2016

Related U.S. Application Data
(60) Provisional application No. 61/845,259, filed on Jul. 11, 2013.

(51) Int. Cl. H04W 72/12; H04W 72/04; H04L 5/00

(52) U.S. Cl. CPC H04W 72/1284; H04L 5/0032; H04W 72/048; H04W 84/12

(57) ABSTRACT

Methods and apparatus are presented for WiFi sectorization and beamforming. In one embodiment, an access point (AP) may send a Request to Send (RTS) to a first station (STA), receive a Sectorized Coordinated Beam (CB/S)-Clear to Send (CTS) from the first STA, and receive a CBS-CTS from a second STA. The AP may then send a Null Data Packet (NDP) Announcement (NDPA), followed by a NDP. The NDP may be sent using sub-sector beamforming. The AP may receive feedback from the first STA, and may create a targeted beam to transmit data to the first STA. The AP may determine sector order and timing based on the feedback. The AP may also identify whether the STA is a sector-edge STA or non-sector-edge (or sector center) STA. The AP may allow the STA to transmit based on whether the STA is assigned to the sector-edge or non-sector edge group.

### CROSS REFERENCE TO RELATED APPLICATIONS

This application claims the benefit of U.S. Provisional Application Ser. No. 61/845,259 filed Jul. 11, 2013, the contents of which are hereby incorporated by reference herein.

### BACKGROUND

A wireless local area network (WLAN) in infrastructure basic service set (BSS) mode may have an access point (AP) for the BSS and one or more stations (STAs) associated with the AP. The AP may have access or an interface to a distribution system (DS) or another type of wired/wireless network that carries traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS may also be sent through the AP, wherein the source STA sends traffic to the AP, and the AP delivers the traffic to the destination STA.

APs may be capable of transmitting using multiple sectorized antennas. These antennas may allow APs to transmit to STAs within a given sector while reducing the interference experienced by STAs outside of that sector. To enable improved cell coverage, and improved spectral efficiency, it may be desirable to coordinate between APs and STAs for sectorized transmission.

### SUMMARY

Methods and apparatus are presented for WiFi sectorization and beamforming. In a first embodiment, an access point (AP) may send a Request to Send (RTS) to a first station (STA), receive a Sectorized Coordinated Beam (CB/S)-Clear to Send (CTS) from the first STA, and receive a CBS-CTS from a second STA. The AP may then send a Null Data Packet (NDP) Announcement (NDPA), followed by a NDP. The NDP may be sent using sub-sector beamforming. The AP may receive feedback from the first STA, and may create a targeted beam to transmit data to the first STA.

In another embodiment, an AP may send a sector training announcement to a STA. The AP may receive feedback from the STA that includes an indication of a best sector, and may send data to the STA based on the feedback.

In one embodiment, an AP may receive feedback from a STA that includes a sector ID feedback frame. The sector ID feedback frame may include at least one of a buffer delay, a current contention window value, and a traffic priority. The AP may determine sector order and timing based on the feedback. The AP may also identify whether the STA is a sector-edge STA or non-sector-edge (or sector center) STA. The AP may allow the STA to transmit during a first portion of a sector duration on a condition that the STA is a sector-edge STA or during a second portion of a sector duration on a condition that the STA is a non-sector-edge STA.

In one embodiment, an AP may send an indication of a signal to noise ratio (SNR) interval and threshold, wherein the indication prompts a STA to initiate a sector training procedure on a condition that an SNR measured by the STA is larger than the indicated SNR threshold.

In one embodiment, the AP may send an indication of a SNR_delta interval and threshold, wherein SNR_delta=max(SNR)−SNR_operating_sector, and wherein the indication prompts a STA to initiate a sector training procedure on a condition that an SNR_delta measured by the STA is larger than the indicated SNR_delta threshold.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows Type 0 sectorization in IEEE 802.11ah;

FIG. 3 is an illustration of Spatially Orthogonal (SO) Condition 1;

FIG. 4 is an illustration of SO Condition 2;

FIG. 5 is an illustration of SO Condition 3;

FIG. 6 is an illustration of SO Condition 4;

FIG. 7 is an illustration of CTS-to-self to facilitate SO detection;

FIG. 8 is an illustration of periodic sector training;

FIG. 9 shows an example of the SO condition;

FIG. 10 shows a Coordinated Beamforming (CB) and Sectorized CB (CB/S) transmission pre-selection procedure;

FIG. 11 shows coordinated sectorization with beamforming with both APs actively avoiding offering interference, and with omni feedback from the STA;

FIG. 12 shows coordinated sectorization with beamforming with both APs actively avoiding offering interference, wherein one AP transmits data that is beamformed and sectorized based on implicit feedback;

FIG. 13 shows coordinated sectorization with beamforming with both APs actively avoiding offering interference, and with beamformed feedback from one STA;

FIG. 14 is an example procedure using explicit and implicit channel state feedback;

FIG. 15 shows a multi-resolution sectorized network;

FIG. 16A is a call flow diagram for a multi-resolution sectorization procedure;

FIG. 16B is a diagram of a multi-resolution sectorization example;

FIG. 17A is a call flow diagram of a procedure for Type 0 sectorization for use in dense cell deployments;

FIG. 17B is a diagram of an example using Type 0 sectorization in dense cell deployments;

FIG. 18 shows the inability of a priority STA to gain access due to sector transmission/reception (Tx/Rx);

FIG. 19 shows an example in which the non-restricted STAs may be able to communicate with the AP during all sector intervals;

FIG. 20 is a call flow diagram of a procedure for implementing Type 0 sectorization with fractional CSMA in dense cell deployments for carrier grade networks with overlapping BSSs;

FIG. 21 shows an example system using Type 0 sectorization with fractional CSMA showing sector edge and non-sector-edge STAs;

FIG. 22 is a diagram of an example using Type 0 sectorization with fractional CSMA showing sector edge and non-sector-edge STAs for HEW;

FIG. 23 is a diagram of an example using Type 0 sectorization with fractional CSMA showing sector edge and non-sector-edge STAs for IEEE 802.11ah+; and

FIG. 24 shows an example system using Type 0 sectorization with fractional CSMA across adjacent sectors.

### DETAILED DESCRIPTION

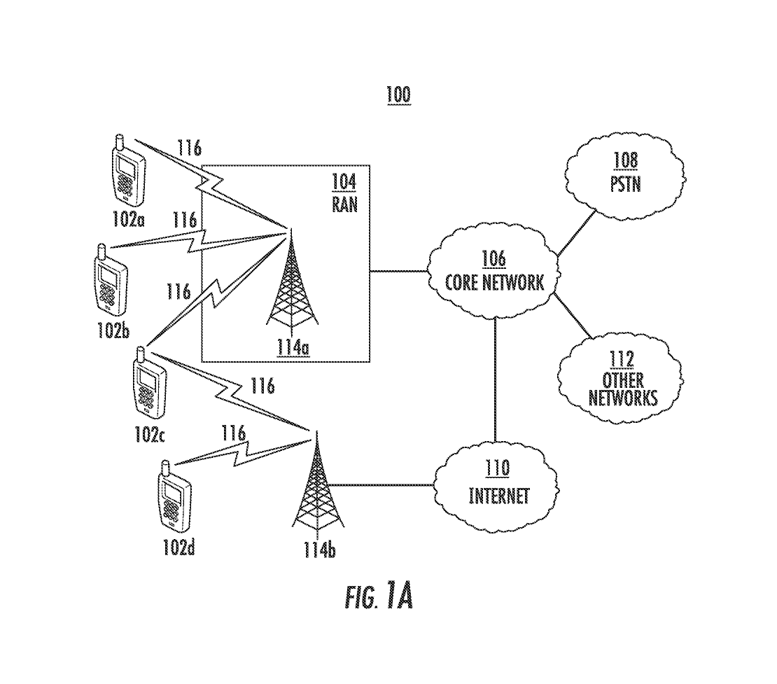

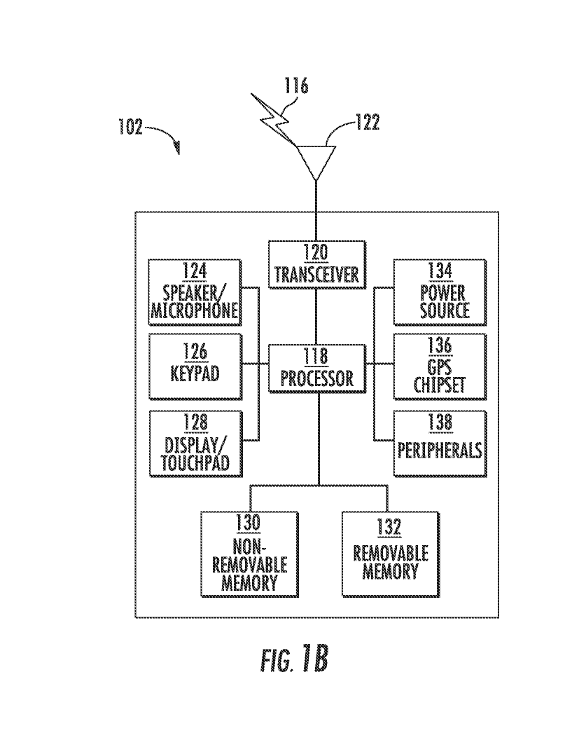

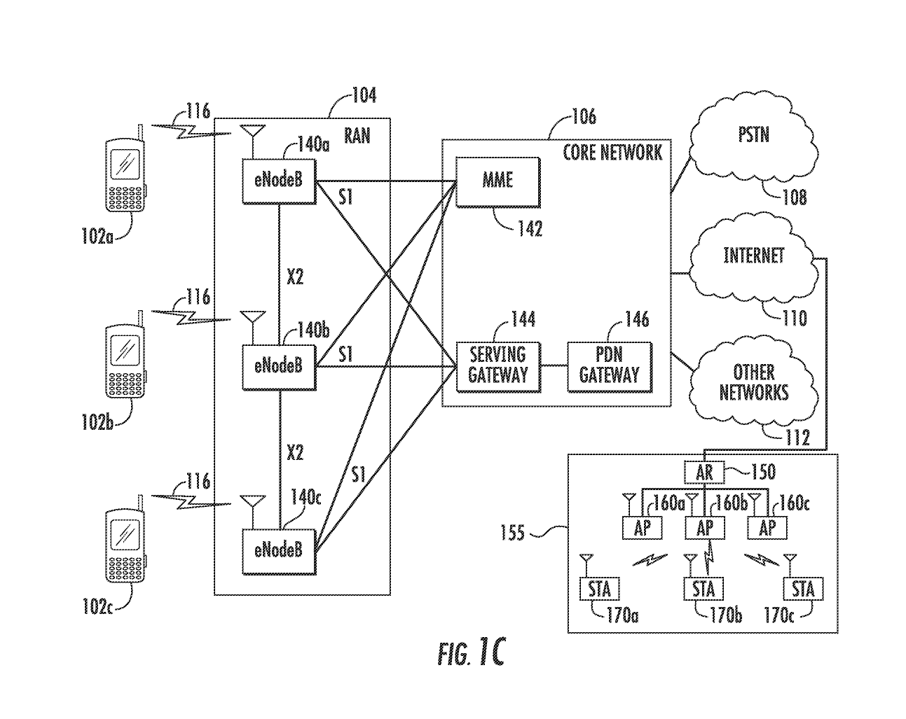

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ E-UTRA radio technology to communicate with the WTRUs 102a, 102b, 102c over the air interface 116.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

When referred to herein, the terminology “STA” may include but is not limited to a station (STA), wireless transmit/receive unit (WTRU), a user equipment (UE), a mobile station, a fixed or mobile subscriber unit, a pager, a cellular telephone, a personal digital assistant (PDA), a computer, a mobile Internet device (MID) or any other type of user device capable of operating in a wireless environment. When referred to herein, the terminology “AP” includes but is not limited to an access point (AP), a base station, a Node-B, an eNode-B, a site controller, or the like.

A WLAN in Infrastructure Basic Service Set (BSS) mode may have an AP for the BSS and one or more STAs associated with the AP. The AP may have access or an interface to a Distribution System (DS) or another type of wired/wireless network that carries traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS may also be sent through the AP where the source STA sends traffic to the AP and the AP delivers the traffic to the destination STA. Such traffic between STAs within a BSS may be peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, so STAs communicate directly with each other. This mode of communication is referred to as an “ad-hoc” mode of communication.

Using the 802.11 infrastructure mode of operation, the AP may transmit a beacon on a fixed channel, usually the primary channel. This channel may be 20 MHz wide, and may be the operating channel of the BSS. This channel may also be used by the STAs to establish a connection with the AP. The fundamental channel access mechanism in an 802.11 system is Carrier Sense Multiple Access with Collision Avoidance (CSMA/CA). In this mode of operation, every STA, including the AP, may sense the primary channel. If the channel is detected to be busy, the STA may back off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel. 802.11n may operate on the 2.4 GHz and 5 GHz ISM bands.

In 802.11ac, Very High Throughput (VHT) STAs may support 20 MHz, 40 MHz, 80 MHz, and 160 MHz wide channels. The 40 MHz and 80 MHz channels may be formed by combining contiguous 20 MHz channels similar to 802.11n described above. A 160 MHz channel may be formed either by combining 8 contiguous 20 MHz channels, or by combining two non-contiguous 80 MHz channels. This may also be referred to as an 80+80 configuration. For the 80+80 configuration, the data, after channel encoding, may be passed through a segment parser that divides it into two streams. IFFT and time domain processing may be done on each stream separately. The streams may then be mapped on to the two channels, and the data may be transmitted. At the receiver, this mechanism is reversed, and the combined data may be sent to the MAC. 802.11ac operates on the 5 GHz ISM band.

Sub 1 GHz modes of operation may be supported by 802.11af and 802.11ah. For these specifications the channel operating bandwidths may be reduced relative to those used in 802.11n and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using a non-TVWS spectrum. A possible use case for 802.11ah is to support Meter Type Control (MTC) devices in a macro coverage area. MTC devices may have limited capabilities including only support for limited bandwidths, but may also include a requirement for a very long battery life.

In 802.11ad, Very High Throughput (VHT) using the 60 GHz band has been introduced. Wide bandwidth spectrum at 60 GHz is available, thus enabling very high throughput operation. 802.11ad may support up to 2 GHz operating bandwidths, and the data rate may reach up to 6 Gbps. The propagation loss at 60 GHz may be more significant than at the 2.4 GHz and 5 GHz bands, and therefore beamforming has been adopted in 802.11ad as a means to extend the coverage range. To support the receiver requirements for this band, the 802.11ad MAC layer has been modified in several areas. One significant modification to the MAC includes procedures to allow channel estimation training. These procedures include omni and beamformed modes of operation which do not exist in 802.11ac.

WLAN systems that support multiple channels and channel widths, such as 802.11n, 802.11ac, 802.11af, and 802.11ah, may include a channel that is designated as the primary channel. The primary channel may, but not necessarily, have a bandwidth equal to the largest common operating bandwidth supported by all STAs in the BSS. The bandwidth of the primary channel may therefore be limited by the STA of all of the STAs operating in a BSS that supports the smallest bandwidth operating mode. In the example of 802.11ah, the primary channel may be 1 MHz wide if there are STAs (e.g. MTC type devices) that only support a 1 MHz mode even if the AP, and other STAs in the BSS, support 2 MHz, 4 MHz, 8 MHz, 16 MHz, or other channel bandwidth operating modes. All carrier sensing and network allocation vector (NAV) settings may depend on the status of the primary channel. If the primary channel is busy, for example, due to a STA supporting only a 1 MHz operating mode that is transmitting to the AP, then the entire available frequency band may be considered busy even though the majority of it remains idle and available.

In the United States, the available frequency band which may be used by 802.11ah may range from 902 MHz to 928 MHz. In Korea it may range from 917.5 MHz to 923.5 MHz; and in Japan, it may range from 916.5 MHz to 927.5 MHz. The total bandwidth available for 802.11ah is 6 MHz to 26 MHz depending on the country code.

Sectorization operations have been discussed in the IEEE 802.11ah TG. In these types of systems, it may be assumed that an 802.11ah AP may conduct sectorized transmissions, while an 802.11 non-AP may conduct omni-directional transmissions.

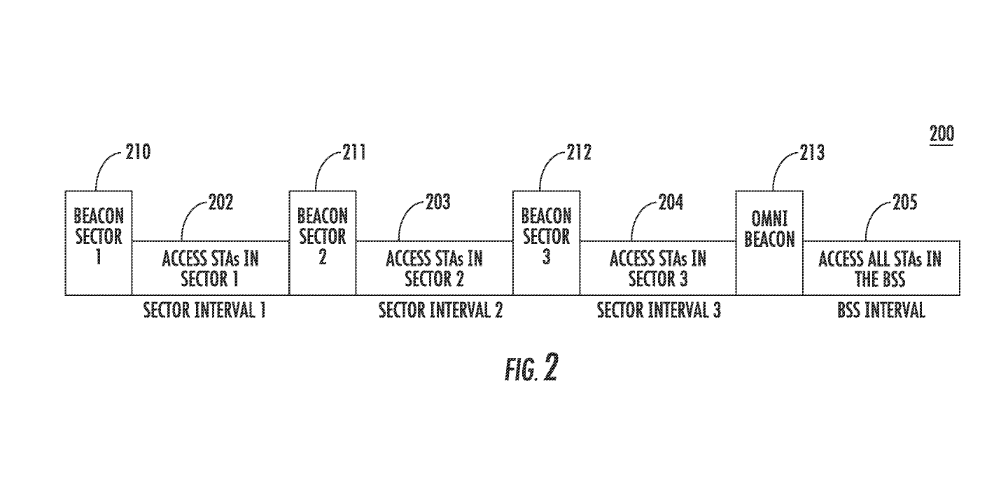

FIG. 2 is a diagram of a first type of system 200 supporting sectorization. In this first type of system, the AP may perform sectorization for hidden node mitigation, also known as Type 0 sectorization. In sectorization for hidden node mitigation, as illustrated in FIG. 2, the AP may divide the space in multiple sectors 202, 203, and 204 and may use a TDM approach to allow STA transmissions in one sector at the time. The AP may transmit a beacon 210, 211, 212, or 213 prior to each sector interval. STAs may be allowed to transmit and receive data only in the time interval corresponding with their respective sector. Time intervals may be left for channel access by all sectors at the same time such as the BSS interval 205.

A second type of system for sectorization may be sectorized beam operation, or Type 1 sectorization. An AP in Type 1 Sectorization may both transmit and receive using omni- and sectorized beams. In this type of system, the AP may switch back and forth between sectorized beam(s) and an omni beam. The sectorized beam may be used only when the AP is aware of the STA's best sector, in a scheduled transmission such as a restricted access window (RAW), or during the transmission opportunity (TXOP) of a STA. The AP may switch back to omni mode otherwise. The sectorized transmit beam may be used in conjunction with the sectorized receive beam. The AP may associate STAs with a specific group (same sector/group ID) based on each STA's best sector.

An AP may also perform sectorized beam operation follow up. Four Spatially Orthogonal (SO) conditions are associated with Type 1 sectorized operations. The SO (Spatially Orthogonal) condition may be defined as an OBSS STA/AP which receives the omni transmission but not the sectorized transmission from the AP (which is either the TXOP holder or responder) or the transmission from the STA (which is either the TXOP responder or holder).

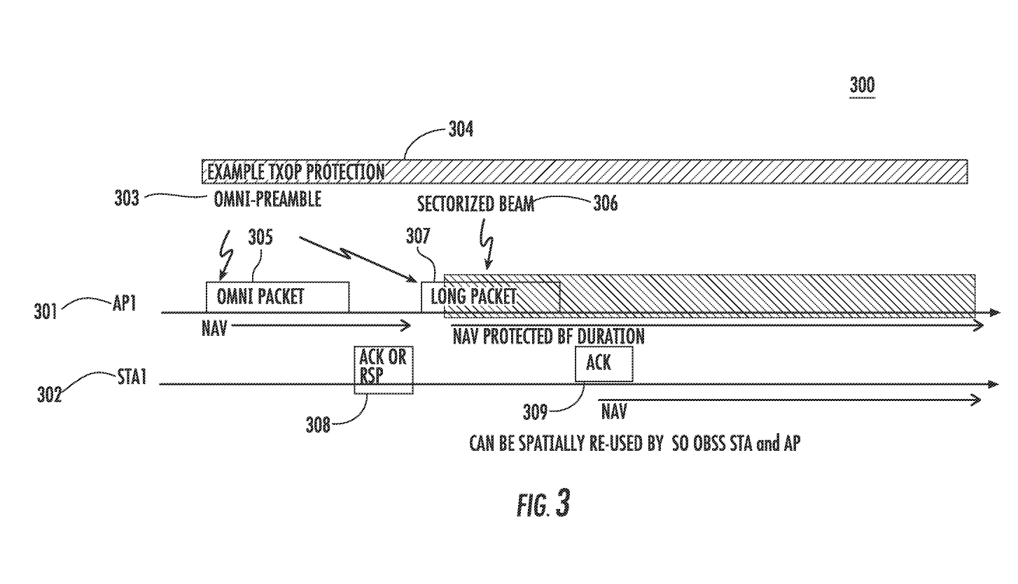

FIG. 3 is an example diagram of SO Condition 1 300. In this SO Condition 1 example, AP 301 may use an omni-preamble 303 to set up TXOP protection 304 for the sectorized beam transmission. Once the proper TXOP protection is set up with omni packet 305 and long packet 307 following ACK 308 and 309 from STA 1 302, the sectorized transmission 306 (with greenfield beamforming (BF)) may be used for the remainder of the TXOP. The SO condition may be confirmed by an OBSS STA/AP not receiving the transmission of STA 1 302 (OBSS STA expects a following STA 1 transmission when it sees Ack Ind=00, 10, Ack Ind=11/Ack Policy=00 in the AP1 Omni packet), or AP1's sectorized transmission portion within the long packet.

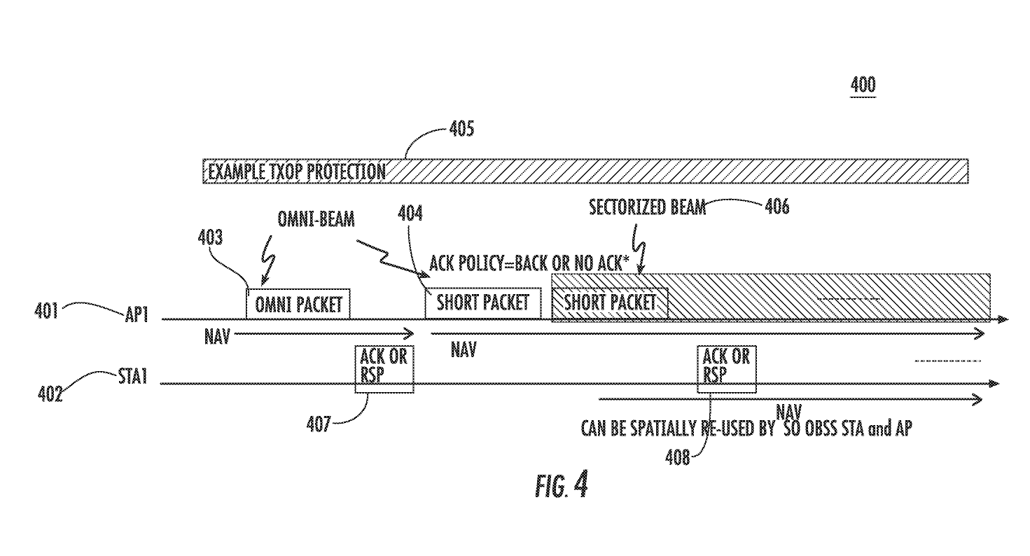

FIG. 4 is an example diagram of SO Condition 2 400. In this SO Condition 2 example, AP 401 may also use an omni packet 403 with short packet 404 to set up TXOP protection 405 for the sectorized beam transmission 406. As shown in FIG. 4, the TXOP protection may be set up at the second transmission by AP 401. Once the proper TXOP protection is set up following ACKs 407 and 408, the sectorized transmission (with greenfield beamforming) may be used for the remainder of the TXOP. The SO condition may be confirmed by an overlapping BSS (OBSS) STA/AP not receiving the transmission of STA 1 402 (OBSS STA expects a following STA1 transmission when it sees Ack Ind=00, 10, or Ack Ind=11/Ack Policy=00 in the AP1 Omni packet)), or AP1's sectorized transmission (following the omni packet with ACK Policy=Block Ack*).

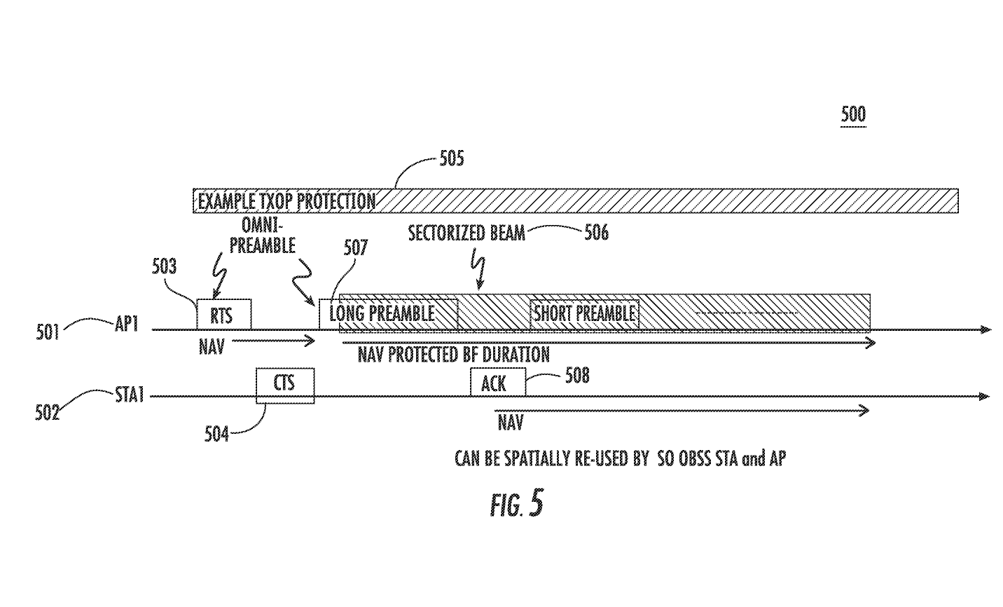

FIG. 5 is an example diagram of SO Condition 3 500. In this SO Condition 3 example, AP 501 may start a frame exchange with an omni request to send (RTS) 503 to solicit a clear to send (CTS) 504 response from STA 502. As shown in FIG. 5, the AP may then use the omni-transmission long preamble 507 to set up the protection 505 for the duration of the sectorized beam transmission and then switch to the sectorized beam transmission 506 for the remainder of the protected duration following ACK 508. The SO condition may be confirmed by an OBSS station or AP which observes the omni-transmission of the AP but not the beamformed transmission of the AP and not the station's transmission. Note that an OBSS station or OBSS AP infers its spatial orthogonality with the AP by observing the omni RTS and omni-preamble of long preamble 507 but not the subsequent sectorized beam transmission and with the station by observing a gap of no transmission between the omni RTS and the omni-preamble of the long preamble. Alternatively, an OBSS station or OBSS AP infers its spatial orthogonality with the AP by observing the omni-RTS and the omni-beam short packet transmission but not observing the subsequent sectorized beam transmission and with the station by observing a gap of no transmission between the omni-RTS and the omni-beam short packets by the AP. Alternatively or additionally, AP 501 may transmit an omni short preamble rather than the long preamble as described above.

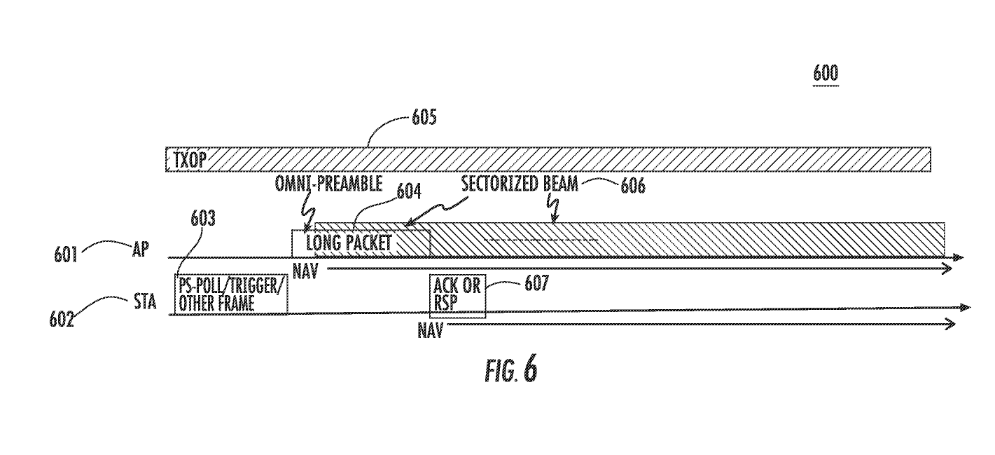

FIG. 6 is an example diagram of SO Condition 4 600. In this SO Condition 4, STA 602 transmits a PS-Poll/Trigger or other frame 603 and then AP 601 sets up the protection by omni transmission long packet 604 for a duration within a TXOP 605 and if the SO condition is confirmed by an OBSS STA/AP, the OBSS STA/AP may cancel its NAV to initiate a new SO exchange starting with a non-BF RTS/CTS. As shown in FIG. 6, once an AP switches to the sectorized beam transmission 606 following ACK 607 during an exchange, it may continue with greenfield sectorized beam transmission for the remainder of the protected duration. Alternatively or additionally, AP 601 may transmit an omni short packet rather than the long packet as described above.

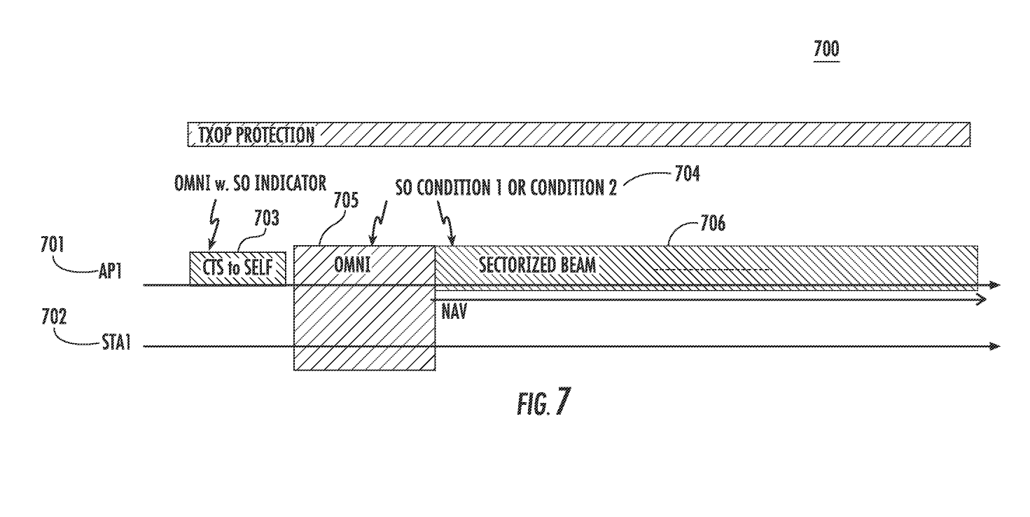

FIG. 7 is a diagram of an example of yet another sectorized beam operation 700. In this example, information elements for Type 0 and Type 1 sectorization that include a 1-bit sector ID indicator in a CTS-to-Self 703 may be transmitted by AP 701, which precedes SO conditions 1 or 2 704, to facilitate the detection of the SO conditions. Following transmission of omni packet 705 to STA 702, AP 701 may transmit using a sectorized beam 706.

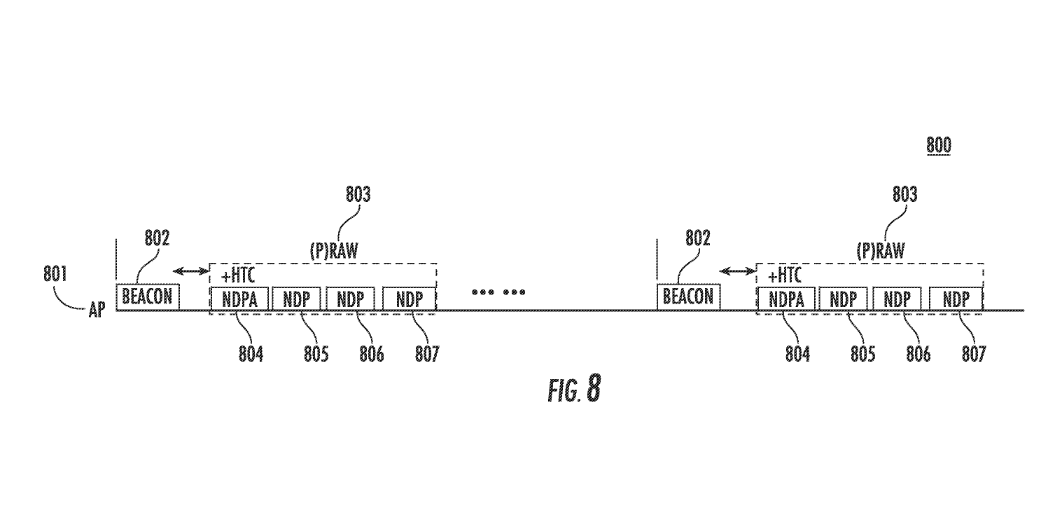

FIG. 8 is a diagram of an example of yet another sectorized beam operation 800, which includes sector ID feedback signaling and procedures. The procedure may begin by AP 801 transmitting beacon 802 followed by RAW 803 including transmitting NDPA 804, and NDPs 805, 806, and 807. The sequence may then be repeated.

In 802.11ad, STAs and APs may be assumed to conduct sectorized beam transmissions. A beamformed TXOP may be reserved by transmitting beamformed Request to Send (RTS)/Directional Multi-Gigabits (DMG) and Clear to Send (CTS) frames. The STAs that receive the RTS/DMG CTS may obey their NAVs. A recipient DMG STA which receives a valid RTS from the source STA during a Service Period (SP) may also transmit a DMG DTS (Denial to Send) to inform the source STA to postpone transmissions if one of the NAV timers at the recipient STA is non-zero.

A Personal IBSS (PBSS) Control Point (PCP) may request a pair of STAs that intend to conduct directional transmissions to each other to conduct measurements while another pair of STAs is actively transmitting directionally; subsequently, the PCP may request that the second pair of STAs conduct directional measurements while the first pair of STAs transmit directionally to each other. If both pairs of STAs report no or little interference from each other's transmissions, the two pairs of STAs may be scheduled in the same Service Period (SP) to conduct concurrent directional transmissions.

One issue includes the potential limitation in the number of AP/STA pairs that are spatially orthogonal based on sectorized transmission at the AP and omni-directional transmission from the STA. In a dense WLAN network that consists of a large number of APs and a large number of STAs, the BSSs may overlap. As a result, there may be scenarios in which the conditions for Spatial Orthogonality (SO) may not be possible.

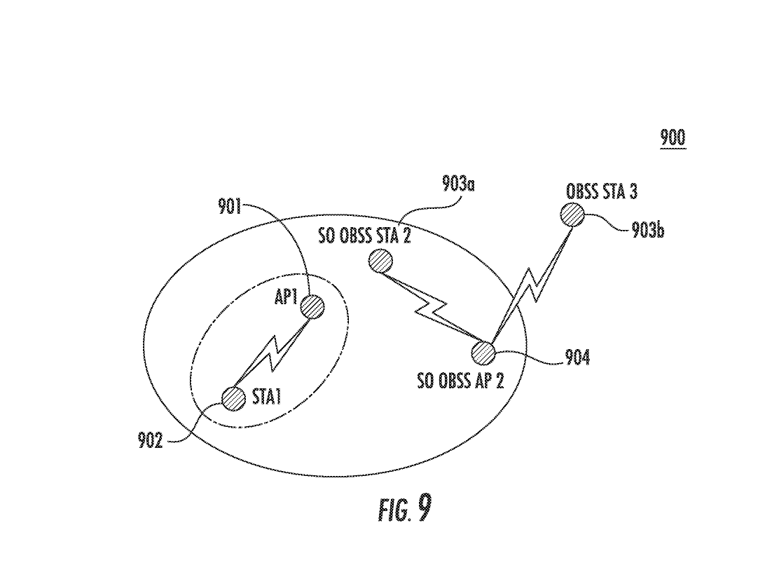

FIG. 9 is a diagram of a system illustrating the Spatial Orthogonality (SO) condition 900. As noted above, the SO condition may be satisfied if an OBSS station 903a and 903b or an AP 904 receives an omnidirectional transmission but not the subsequent sectorized beam transmission from the sectorized AP 901, nor the associated transmission from the sectorized STA 902. The need for, or occurrence of, the SO condition frequently occurs in the context of sectorized transmissions. For example, 802.11ah defines two types of sectorized operation, Type 0 and Type 1, as described above. The SO pairs illustrated in FIG. 9 that may be possible using Type 1 sectorization may be limited. Methods that incorporate beamforming in addition to sectorization are described herein to ensure either conditional or mutual spatial orthogonality between the AP/STA pairs.

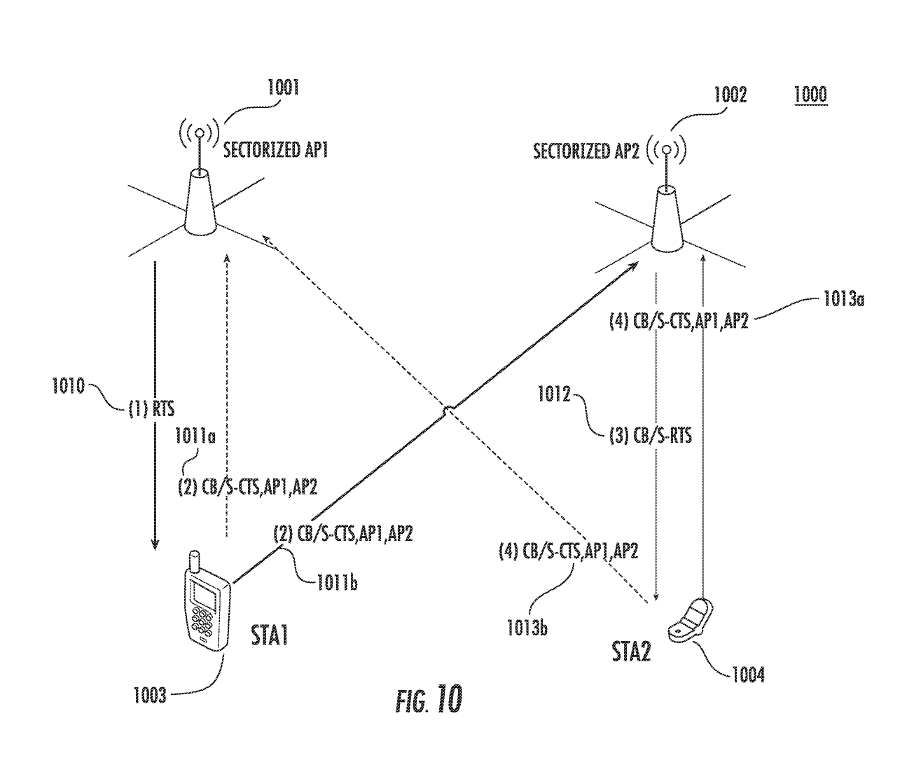

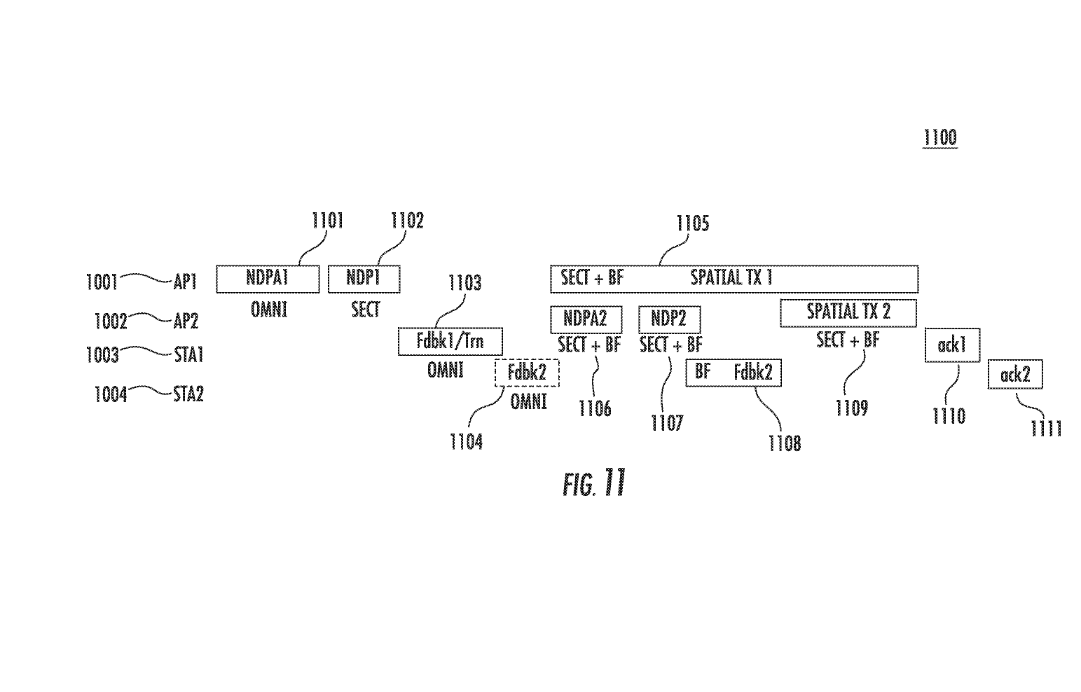

FIGS. 10-11 are diagrams of procedures that may combine beamforming and sectorization to limit the amount of interference between multiple transmit-receive pairs in accordance with one embodiment, which may be used in combination with any of the embodiments described herein. This embodiment may include the use of coordinated, beamformed, and sectorized transmissions using explicit and/or implicit channel state feedback in a WLAN sectorized network. In this embodiment it may also be assumed that multiple transmit-receive pairs are actively avoiding sending interference to each other by using both sectorization and beamforming. As such, a procedure may be necessary to pre-select the transmit-receive pairs. The STA may be an advanced STA that is capable of beamforming to its AP, which may thereby further reduce interference.

In the procedure 1000 of FIG. 10, the network may select the transmit-receive pairs. After a normal CSMA/CA procedure, AP1 1001 may acquire the channel and may send a request to send (RTS) 1010 to STA1 1003 in a first sector, which may be referred to as sector x in this example. If STA1 1003 is available, STA1 1003 may respond by transmitting a Sectorized Coordinated Beamforming—Clear to Send (CB/S-CTS) 1011a and 1011b to AP1 1001 and AP2 1002, respectively. This response may include information that may indicate to AP1 1001 and AP2 1002 that it needs interference avoidance.

AP2 1002 may then acquire the channel and send a CB/S-RTS 1012 to STA2 1004 in a second sector, which may be referred to as sector y in this example. If STA2 1004 is available, it may then reply with CB/S-CTS 1013a and 1013b to AP1 1001 and AP2 1002, respectively, to indicate that CB/S pairs are selected. Note that in a scenario in which AP1 1001 may not overhear transmission by STA2 1004, AP2 1002 may send an CB/S-ACK to STA1 1003 which may then send an CB/S-ACK to AP1 1001.

FIG. 11 is a diagram of a procedure 1100 that may be performed once the transmit-receive pairs are selected for transmission as described above. AP1 1001 may send an Null Data Packet Announcement (NDPA) 1101 using an omni-transmission to start the transmission and reserve the channel in BSS1. Note that the CB/S-RTS/CB/S-CTS messages have reserved the channel in BSS2. AP1 1001 may then send an Null Data Packet (NDP) 1102 to enable both STA 1003 and STA 1004 to estimate the best beam for transmission. If full beamforming and sectorization is available, AP1 1001 may send out a single NDP 1102 that is modified by the sector beam. Alternatively or additionally, if sub-sector beamforming is available in which the AP may use a sub-sector of the original sector for transmission, the AP may send out multiple NDPs, one for each sub-sector to be tested. STA1 1003 may then send explicit feedback 1103 to AP1 1001. If full beamforming is available, STA1 1003 may, for example, use compressed beamforming weight feedback based on a Givens rotation. STA2 1004 may also send explicit feedback 1104 to AP1 1001 to enable AP1 1001 to create a beam that avoids STA2 1004. If sub-sector beamforming is available in which the AP may use a sub-sector of the original sector for transmission, STA1 1003 may feedback the desired sub-sector beam. In this case, sector y in AP2 1002 may be selected to minimize the impact of AP1 1001 on STA2 1004. The sub-sector beam selection may further minimize this impact.

Once AP1 1001 has received feedback 1103 from the STA 1003, AP1 1001 may create a targeted beam within sector x and may begin transmitting data 1105 to STA1 1003. AP2 1002 may use the long training field (LTF) from STA1′s feedback to identify the channel of STA1 1003 channel based on channel reciprocity (implicit feedback). STA2 1004 may use the NDP 1102 from AP1 1001 and the LTF from STA1 1003 to identify channels based on reciprocity. AP2 1002 may then combine beamforming and sectorization to transmit data to STA2.

As illustrated in FIG. 11, AP2 may send out an NDPA 1106 and NDP 1107 that are beamformed and sectorized to avoid impacting STA1 1003. STA2 1004 may send feedback 1108 that is beamformed to transmit directly to AP2 1004. AP2 1004 may take the feedback and improve the BF to STA2 1004 and then transmit data 1109 to STA2. Note that AP2 1002 may transmit data on a sub-sector within the selected sector in the case of sub-sector beamforming. STA1 1003 may send back an ACK 1110, and STA2 1004 may send back an ACK 1111.

Note that there may be a need to make sure that AP2 1002 and STA2 1003 are spatially orthogonal (SO) to AP1 1001 and STA1 1003 and vice versa. The scheme may achieve this by forcing mutual SO using beamforming. STA2 1004 may send feedback 1104 to AP1 1001 to allow AP1 1001 to improve its orthogonality to STA2 1004.

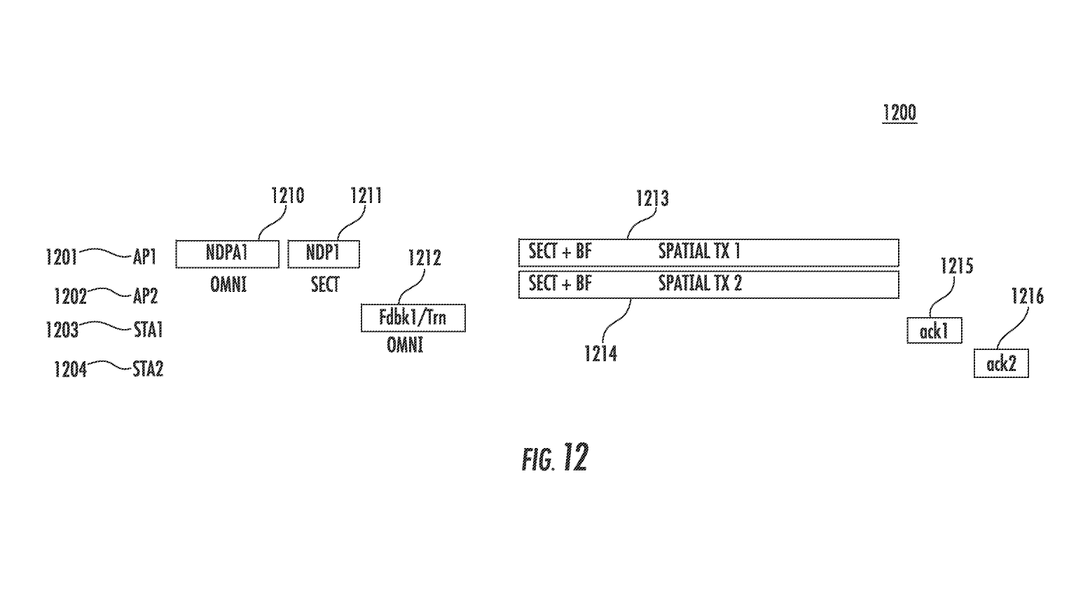

FIG. 12 is an example procedure 1200 in which a second transmit-receive pair (the secondary transmission) may be actively avoiding sending interference to a first transmit-receive pair (the primary transmission) using both sectorization, beamforming, or null-beamforming (hereafter referred to as beamforming). The primary transmission may assume that it is the only pair in the channel. In this case, the second transmit receive-pair may be spatially orthogonal to the first pair. The procedure differs from basic IEEE802.11ah Type 1 sectorization by allowing the secondary transmission to force spatial orthogonality by use of sectorization and beamforming based on channel information received from the primary transmission. The STAs may be STAs that transmit omni-directionally to its AP or may be advanced STAs with the capability of beamforming or precoding transmissions to its AP, which may thereby further reduce interference.

In the procedure of FIG. 12, the network may select the transmit-receive pairs. A pair may also consist of a group of STAs, wherein there is a single AP paired with a group of STAs. In this example procedure, STA1 1203 may refer to a group of STAs which are identified as belonging to the same association with the AP as STA1 1203. Similarly, STA2 1204 may refer to a group of STAs which are identified as belonging to the same association with the AP as STA2 1204. AP2 may refer to a group of APs.

In this example procedure, it is assumed that AP1 1201 and STA1 1203 have been selected as a first transmit-receive pair (the primary transmission) using traditional Carrier Sensing Multiple Access/Collision Avoidance (CSMA/CA). Also, in this example procedure it is assumed that AP2 1202 and STA2 1204 transmissions are selected contingent on the AP1 1201 and STA1 1204 transmission. A secondary clear channel assessment (CCA) procedure for the secondary transmission using non-conflicting sectorized transmissions may be used to select AP2 1202 and STA2 1204. After the CSMA/CA procedure, AP1 1201 may acquire the channel and send an RTS to STA1 1203 in a first sector, which may be referred to as sector x in this example. STA1 1203 may reply with a CB/S-CTS to AP1 1201.

AP1 1201 may then send an NDPA 1210 using omni transmission to start the transmission. AP1 1201 may then send an NDP 1211 using sectorized transmission to enable STA1 1203 to estimate the best beam for transmission. If full beamforming and sectorization is available, AP1 1201 may send out a single NDP that is modified by the sector beam. If sub-sector beamforming is available in which the AP may use a sub-sector of the original sector for transmission, AP 1 1201 may send out multiple NDPs. For example, one NDP for each sub-sector to be tested may be sent. Note that spatially orthogonal STA2 1204 may listen to the AP1 1201 transmission of NDP 1211 to enable STA2 1204 to estimate the beamforming parameters that may avoid the AP1 1201 and STA1 1203 transmit-receive pair (the primary transmission) based on reciprocity.

STA1 1203 may send feedback 1212 to AP1 1201. When full beamforming is available, STA1 1203 may use compressed beamforming weight feedback based on a Givens rotation, for example. When sub-sector beamforming is available in which the AP may use a sub-sector of the original sector for transmission, STA1 1203 may send feedback that includes the desired sub-beam. In this example, sector y of AP2 1202 may be selected to minimize the impact on the AP1 1201 and STA1 1203 transmit-receive pair (the primary transmission). Selecting a sub-sector beam may further minimize this impact. Spatially orthogonal AP2 1202 and STA2 1204 may listen to STA1 1203 feedback to enable AP2 1202 and STA2 1204 to estimate the beamforming parameters that may avoid the AP1 1201 and STA1 1203 transmit-receive pair (the primary transmission) based on reciprocity.

AP1 1201 may create a targeted beam within sector x and may begin transmitting data 1213 to STA1 1203. STA1 1203 may then respond with an ACK1 1215. AP2 1202 may use a secondary CCA procedure to decide on an AP2 1202 and STA2 1204 pair. The secondary transmissions may use directional RTS/CTS with combined beamforming and sectorization to avoid STA1 1201. AP2 1202 may then combine beamforming and sectorization to transmit data 1214 to STA2 1204. STA2 1204 may then respond with an ACK2 1216. For example, as illustrated in FIG. 12, AP2 1202 may transmit data that is beamformed and sectorized based on the implicit feedback to avoid impacting STA1 1201.

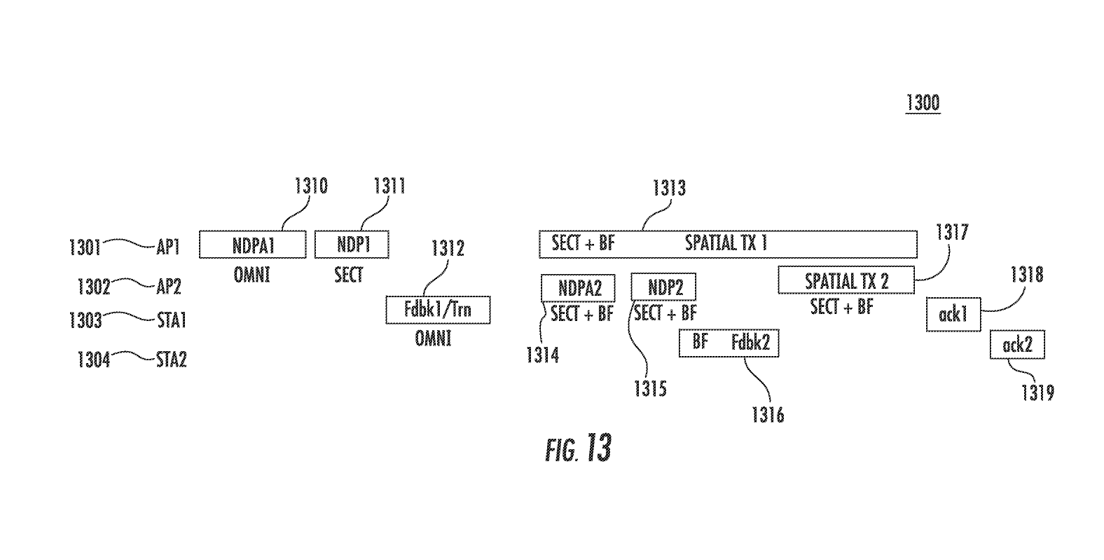

FIG. 13 is another example procedure 1300 for actively avoiding sending interference to a first transmit-receive pair (the primary transmission) using both sectorization and beamforming. As in the previous example, AP1 1301 then send an NDPA 1310 using omni transmission to start the transmission, and then AP1 1301 may then send an NDP 1311 using sectorized transmission to enable STA1 1303 to estimate the best beam for transmission. STA1 1303 then may send feedback 1312 to AP1 1301, and then AP1 1301 may create a targeted beam within a sector and may begin transmitting data 1313 to STA1 1303.

AP2 1302 may then solicit additional beamformed feedback from STA2 1304 to improve the performance of the transmission to STA2 1304 while avoiding STA1 1301. In this example AP2 1302 may send out an NDPA 1314 and NDP 1315 that are beamformed and sectorized to avoid impacting STA1 1303. STA2 1304 may send feedback 1316 that is beamformed to transmit directly to AP2 1304 in order to reduce the probability of impacting the reception of STA1 1201. AP2 1302 may use the feedback to improve beamforming to STA2 1304 and then transmit data 1317 to STA2 1304. Note that AP2 may transmit data on a sub-sector within the selected sector in the case of sub-sector beamforming. STA1 1303 may send back an ACK 1318, followed by STA2 1304 sending back an ACK 1319. In this example, AP2 1302 and STA2 1304 may be spatially orthogonal to AP1 1301 and STA1 1303. AP2 1302 and STA2 1304 may be forced to be spatially orthogonal to AP1 1301 and STA1 1303 by using beamforming.

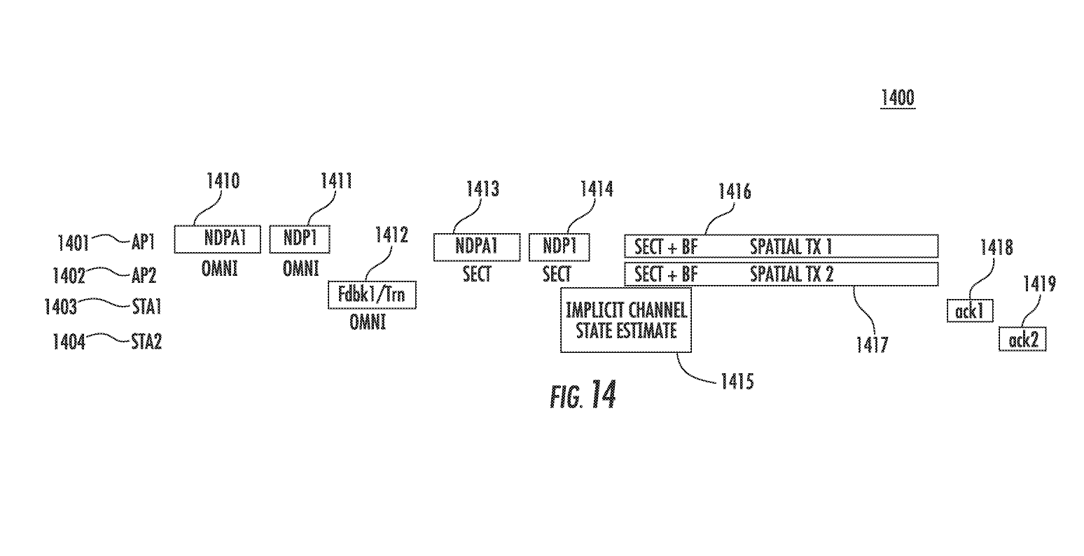

In a variation on the previous example, explicit and implicit channel state feedback may be sent in association with either or both omni and sectorized transmissions. FIG. 14 is an example procedure 1400 using explicit and implicit channel state feedback. Explicit channel state feedback may be implemented using an omni-transmission mode. AP1 1401 may send out an NDPA 1410 and NDP 1411 using omni transmission mode. STA1 1403 may then send feedback 1412 to AP1 1401, again using omni transmission mode.

AP1 1401 may then send out an NDPA 1413 and NDP 1414 using sectorized transmission mode. The AP may then use information derived from the omni based channel state feedback 1412 to facilitate the configuration of subsequent sectorized operation. The sectorized beamforming may then use implicit channel state feedback 1415 in cases when the omni based channel state feedback 1412 enabled the channel or a portion thereof to be more easily estimated than originally possible. AP1 1401 may then transmit data 1416 that is beamformed and sectorized to STA1 1403. AP2 1402 may then transmit data 1417 that is beamformed and sectorized to STA2 1404. STA1 1403 may send back an ACK 1418, followed by STA2 1404 sending back an ACK 1419.

Other combinations of this procedure may be possible. For example implicit channel state feedback may be determined during the configuration for use in subsequent sectorized operation.

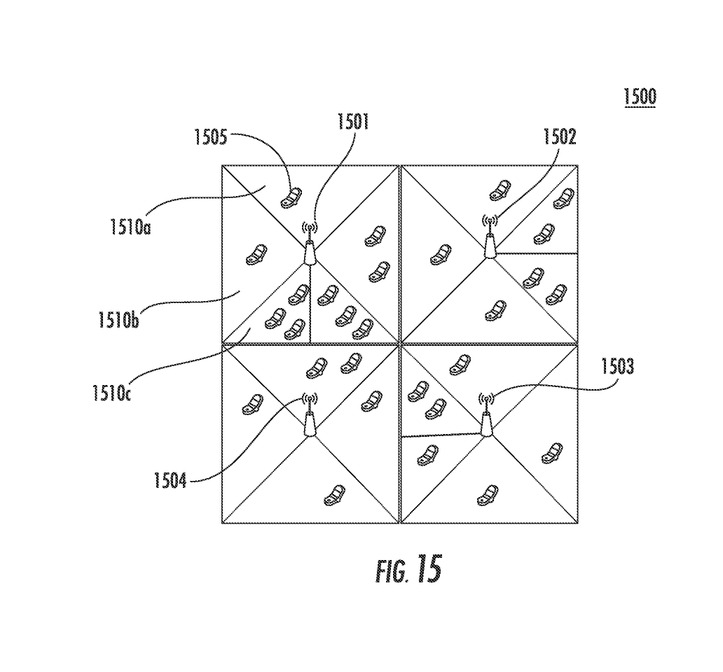

FIG. 15 is a diagram of a system utilizing multi-resolution sectorization 1500 in accordance with another embodiment, which may be used in combination with any of the other embodiments described herein. Multi-resolution sectorization enables multiple levels or resolutions of sectorization in which there may be sectors within sectors. The number of sector levels is an implementation issue. Sectorization with multiple resolutions may allow varying and adaptive beamwidths. Moreover, the number and beamwidth of sectors used in a transmission may also be adapted in a single beacon interval.

As shown in FIG. 15, multi-resolution sectorization may allow for the existence of a very large number of sectors, each which may include varying beamwidths in the BSS without the overhead needed for a large sector discovery procedure. For example, in a system with multiple APs, 1501, 1502, 1503, and 1504, each AP has multiple sectors including for example, sectors 1510a, 1510b, 1510c that may have varying beamwidths. Each sector may include multiple users or STAs 1505. Multi-resolution sectorization may allow the AP to dynamically change the sector beamwidth based on the needs of the network at a specific time. As such, the AP may be able to adjust sectors to areas in which the users are concentrated and improve the directionality of the sectors. Multi-resolution sectorization may also allow for fixed beam transmission to a specific STA. The beam discovery overhead may be controlled to minimize the amount of overhead needed such that NDP transmission for each sector with the position of the training NDP frames corresponding to the sector IDs may not be required.

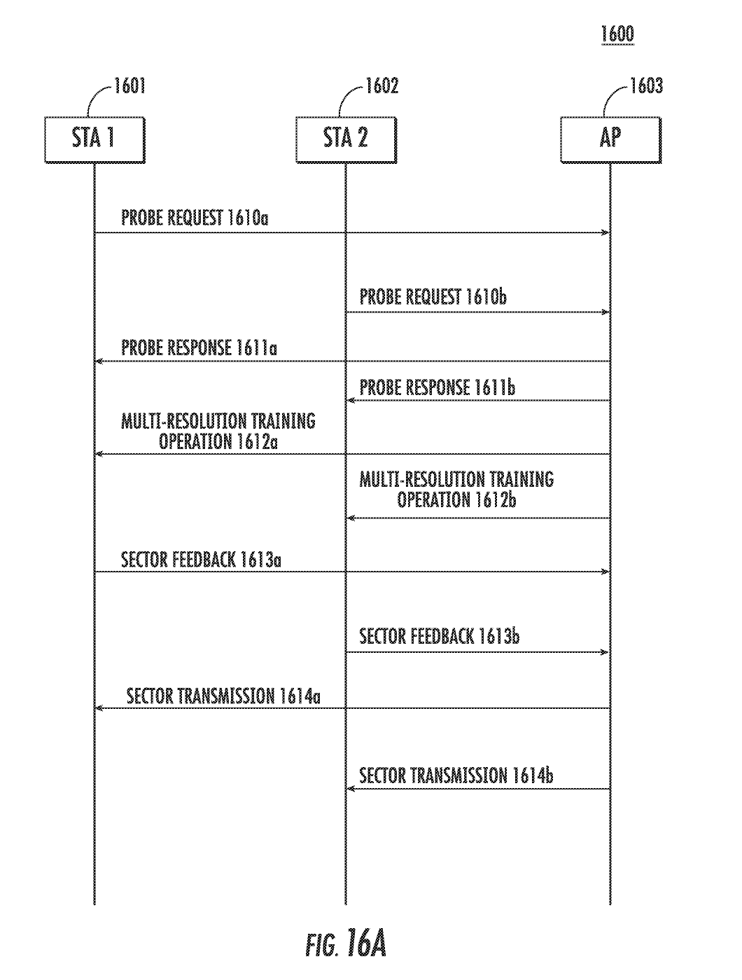

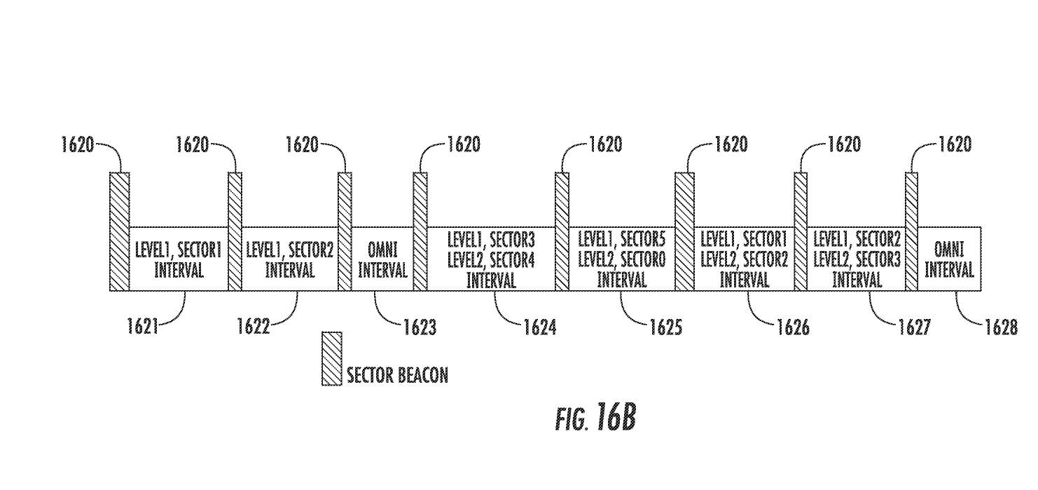

FIG. 16A is a call flow diagram for a multi-resolution sectorization procedure 1600. In the following procedure, the maximum number of sectors in each level is assumed to be 8 (as in IEEE 802.11ah). When a STA joins a network it may indicate that it supports multi-resolution sectorization during the sector capabilities exchange with a BSS. In the example of FIG. 16A, two STAs and one AP are used, but this procedure may be expanded to any number of STAs or APs. In this example, STA1 1601 and STA2 1602 may send out a probe requests 1610a and 1610b to the network/AP 1603. AP 1603 may send out probe responses 1611a and 1611b with the multi-resolution sectorization capability set to true. AP 1603 may then initiate a multi-resolution sector training operation by transmitting sector training messages 1612a and 1612b to identify the number of STAs, their corresponding sector IDs and the actual sectors used. STA1 1601 and STA2 1602 in the BSS may estimate the best sector and feed back the information 1613a and 1613b to AP 1603 using the sector ID feedback frame. AP 1603 may start sector transmission based on the current feedback information. Each STA may add in its feedback frame information on its buffer delay, current contention window value, and traffic priority to assist the AP in setting up the sector order and timing.

Alternatively or additionally, for sector level 1 discovery, the AP may send out a sector training announcement with a multi-resolution sector flag set to 1 and the sector discovery level set to 1.

Alternatively or additionally, for sector level 2 discovery, the AP may send out a sector training announcement with a multi-resolution sector flag set to 1, with the sector discovery level set to 2, and with an indication of the sector ID of the current sector in level 1. The STAs in the BSS that are currently in the current sector ID and STAs that may not have a sector ID selected may estimate the best sub-sector in sector 1 and feed back that information to the AP using the sector ID feedback frame. The sector ID feedback frame may include the sector ID of the level 1 sector. The AP may start sector transmission 1614a and 1614b based on the current feedback information.

Alternatively or additionally, for sector level x discovery, AP may send out a sector training announcement with a multi-resolution sector flag set to 1, with the sector discovery level set to “x”, and with an indication of the sub-sector ID of the current sector in level “x−1”. The STAs in the BSS that are currently in the current sub-sector ID and STAs that may not have a sector ID selected may estimate the best sub-sector in sector “x−1” and feed back the information to the AP using the sector ID feedback frame. The sector ID feedback frame may include the sector ID of all x−1 parent sectors.

The AP may start sector transmission 1614a and 1614b based on the current feedback information. Note that the AP may decide to focus on a subset of sectors at a specific level based on the distribution of the STAs, STA traffic, etc., and increased directionality may be obtained as needed for a specific sector. Also note that NDP overhead may be constant for a given sector level.

Once AP 1603 has the desired multi-resolution sector IDs for some or all of the STAs in the system, AP 1603 may schedule a desired sub-sector within a beacon interval using the sector announcement frame, which may also be used with any of the other embodiments described herein. The announcement frame may include explicit information on the desired sector level and the IDs of each sub-level, for example {start_time, duration, sector_level, sectoredID1, sectorIDx−1, sectorIDx}. Alternatively or additionally, the information may be implicit such that the announcement frame includes the IDs of each sub-level only and each STA has to interpret the desired level, for example, {start_time, duration, sectorID1:sectorIDx−1:sectorIDx}.

Alternatively, AP 1603 may schedule a specific sector level (L1) for transmission. If STA x residing within sector (L1,L2) reserves the channel, the AP may automatically transmit/receive using the higher resolution sector (L1,L2) for increased inter-BSS interference mitigation or increased transmission directivity.

FIG. 16B is a diagram of a multi-resolution sectorization example. In the example of FIG. 16B, following each sector beacon 1620, there is a sector transmission interval in the following order: a level 1, sector 1 interval 1621, a level 1, sector 2 interval 1622, an omni interval 1623, a level 1, sector 3 and level 2, sector 4 interval 1624, a level 1, sector 5 and level 2, sector 0 interval 1625, a level 1, sector 1 and level 2, sector 2 interval 1626, a level 1, sector 2 and level 2, sector 3 interval 1627, and an omni interval 1628.

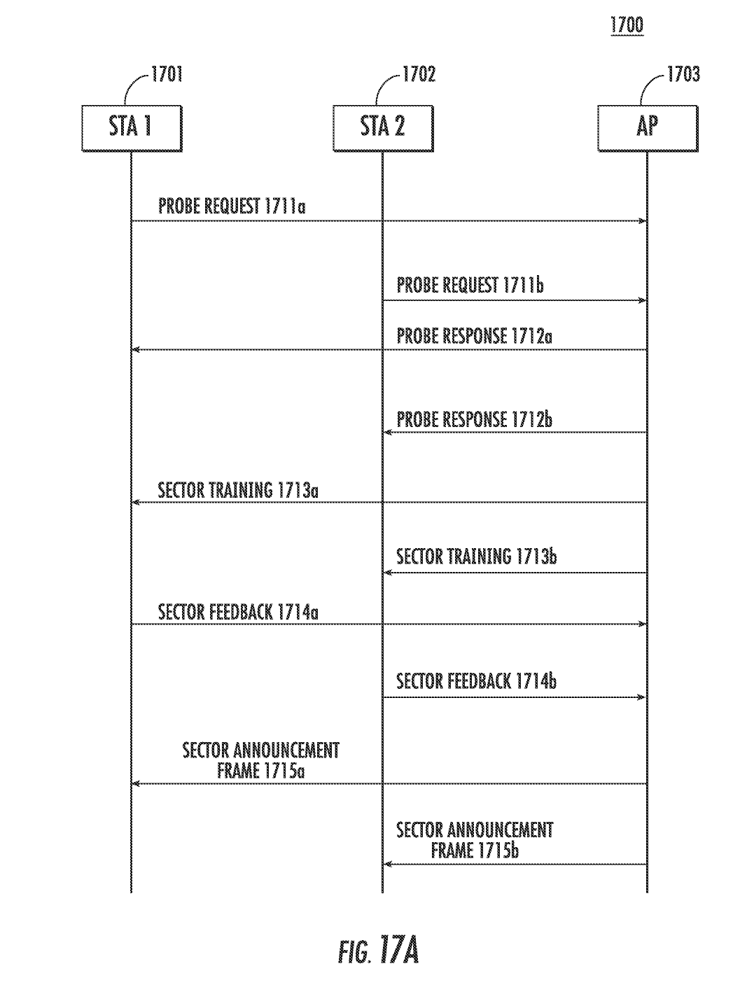

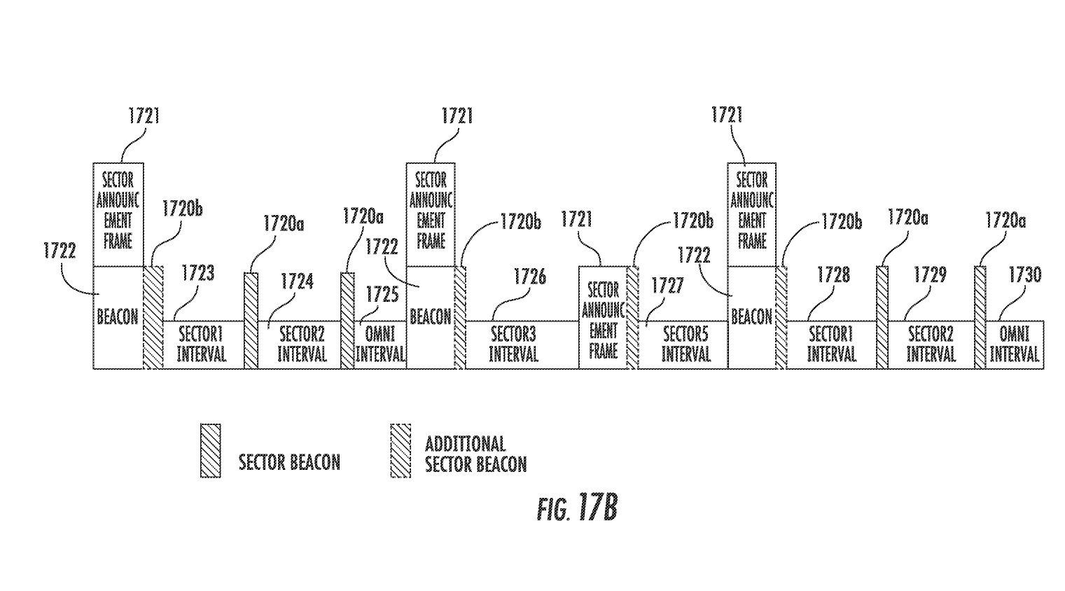

FIG. 17A-17B are diagrams illustrating the use of Type 0 sectorization in dense cell deployments for carrier grade WLAN networks in accordance with yet another embodiment, which may be used in combination with any of the other embodiments described herein. This embodiment proposes methods and procedures which enable support for large number of APs in dense cell deployments for a carrier grade network, such as a High Efficiency WLAN (HEW), using fixed sectorization. A carrier grade network may have a large number of STAs and the STA traffic may have a delay constraint. To improve the fairness of access for the large number of STAs in the network, the use of Type 0 sectorization in which a subset of the STAs in the network (in the direction of the sector) are permitted to access (transmit and receive) the network is proposed. As opposed to the existing Type 0 sectorization in IEEE802.11ah wherein each beacon is dedicated to the transmission of a single sector (see FIG. 2), the methods proposed herein may enable multiple sectors of varying duration to be transmitted in each beacon interval. This may also eliminate unacceptable delay associated with systems that utilize beacons dedicated to a single sector, eliminate difficulty in allowing for a variation in the duration of transmission for each sector, and/or a eliminate difficulty for STAs that are outside the sector overhearing and processing the sector beacon as may occur in systems such as the system of FIG. 2.

In this embodiment, the use of a sector announcement frame is used to allow a variation in the length of time that each sector is active. The sector announcement frame may also allow for an override of the current sector schedule to mitigate the delay constraints that may arise in the case of scheduling a sector based on beacon timing. In the case of extreme traffic delay, the STA may be temporarily moved from a sector specific group to a group that allows access to the network during any sector transmission.

This procedure may eliminate the delay constraint issue associated with the limitation in the number of AP/STA pairs that are spatially orthogonal based on sectorized transmission (at the AP) and omni-directional transmission (from the STA), since STAs may not have to wait for multiple beacon intervals before transmission. Note that multiple sectors may transmit and receive simultaneously if the hardware of the transmitter/receiver so permits. The sector(s) selected and the duration of the transmissions may be decided by the AP based on information such as the number of STAs in the sector, the current traffic delay of the STAs in the sector, the STA priority, etc. The sector announcement frame may include the sector ID and a transmission duration and (a) may be aggregated with the omni-directional beacon, (b) may be incorporated in the omni-directional beacon, or (c) may be transmitted independently when needed. Note that in the case in which it is transmitted independently, it may override any current sector transmission schedule. Aggregating or incorporating the sector announcement frame with/into the omni-directional beacon may provide knowledge of the sector schedule to all STAs in the sector and enables each STA to handle the need for multiple target beacon transmission times (TBTTs) based on the sector that it is assigned to.

FIG. 17A is a call flow diagram of a procedure 1700 for Type 0 sectorization for use in dense cell deployments. When a STA joins a network it may indicate that it supports sectorization during the sector capabilities exchange with its BSS. In the example of FIG. 17A, two STAs and one AP 1703 are used, but this procedure may be expanded to any number of STAs or APs. In this example, STA1 1701 and STA2 1702 may send out a probe request 1711a and 1711b to the network/AP 1703. AP 1703 may send out probe responses 1712a and 1712b with the sectorization capability set to true. AP 1703 may initiate sector training operations by transmitting sector training messages 1713a and 1713b to identify the number of STAs and their corresponding sector IDs. The STA may continually feed information back 1714a and 1714b with each uplink data transmission to provide AP 1703 with the information it may need for managing sector order and duration. In the sector ID feedback frame, each STA1 1701 and STA2 1702 may add information regarding its buffer delay, current contention window value, and traffic priority to the sector ID feedback or as a separate sector information frame to assist the AP in setting up the number of sectors, sector duration, and sector transmission order.

The sector order and timing may be decided by AP 1703 as a function of STA parameters such as the number of STAs in the sector, the contention window values of each STA, the traffic buffer delay, and the traffic priority, among others. The order may also be a function of other BSSs in the network in the case of multi-AP sector coordination to reduce interference. AP 1703 may then send a sector announcement frame 1715a and 1715b to inform STAs in the network of the sector order and timing. This may be sent as part of the beacon and, (a) may be aggregated with the omni-directional beacon, (b) may be incorporated in the omni-directional beacon, or (c) may be transmitted independently. If sent as an independent frame, the current information may override any previous schedule. An explicit sector announcement may include a sector ID, start time, and sector duration. For example, a frame may include the following information: {{Starting_Time_1, Duration_1, Transmission_Sector_1}, . . . , {Starting Time_y, Duration_y, Transmission_Sector_y}} where 1, . . . , y are sector indices. Note that it may not be necessary to schedule all sectors in an omni-directional beacon interval. Note also that omni-directional transmission may also be scheduled. An implicit sector announcement using omni-directional TBTT may include a sector ID and a start time. For example, a frame may include the following: {omni-TBTT{starting_time_1, Transmission_Sector_1}, . . . , {Starting Time_y, Transmission_Sector_y}} where 1, . . . , y are Sector indices. In this case, the starting time may be relative to the omni-directional TBTT and may implicitly signal the duration for each sector.

In another example, the network may schedule a single TBTT for an omni-directional beacon and aggregate the sector announcement frame with this omni-directional beacon. At the beginning of a sector transmission, the AP may transmit a sector beacon to the STAs in the sector. This sector beacon may not override the TBTT for the omni-directional beacon and may be used to provide sector specific information to STAs in the sector. As such, STAs in the sector may implicitly set up multiple TBTTs based on the number of sector groups to which they are assigned.

FIG. 17B is a diagram of an example using Type 0 sectorization in dense cell deployments. In the example of FIG. 17B, sector announcement frame 1721 incorporated with beacon 1722 may be first transmitted. Then sector transmission interval may follow. For example the order may be as follows: sector 1 interval 1723, sector 2 interval 1724, omni interval 1725, sector 3 interval 1726, sector 5 interval 1727, sector 1 interval 1728, sector 2 interval 1729, and omni interval 1730. Also, following the sector announcement frame 1721, additional sector beacons 1720b may be transmitted. Also, as shown in the example of FIG. 17B, sector beacons 1720a may be transmitted in between each sector transmission interval.

Note that as in IEEE802.11ah, some STAs may transmit at any time interval, while the majority of the STAs may restrict their activity to a particular sector interval and the omni time interval.

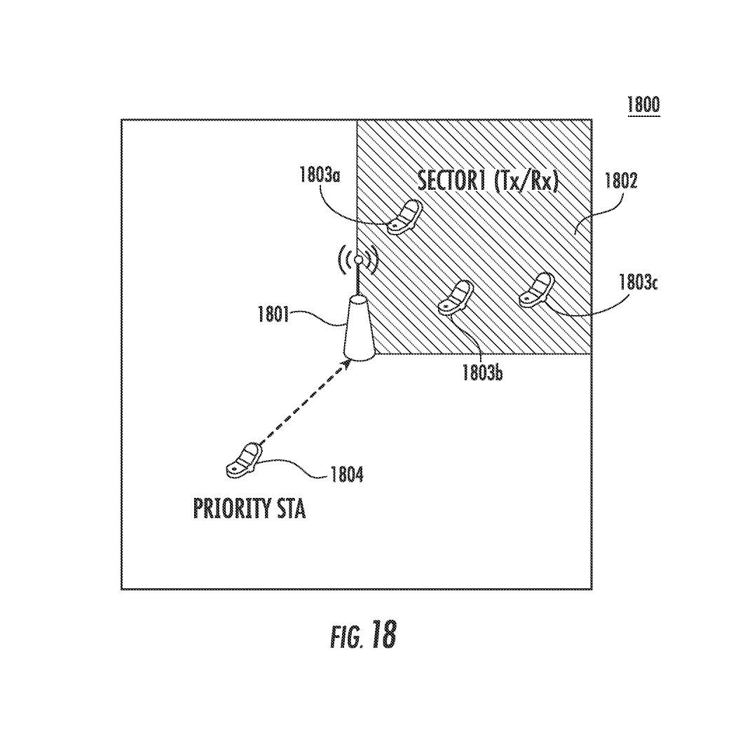

FIG. 18 shows an example 1800 of the inability of a STA 1804 to gain access due to sectorized transmission and reception because it is not in the current sector. In this example, during uplink transmission, the STA 1804 that may transmit at a particular time may not be able to do so because they are located at the back lobe of the sectorized antenna at the AP 1801. In this example, STAs 1803a, 1803b, and 1803c in sector 1 1802 are the only STAs with access.

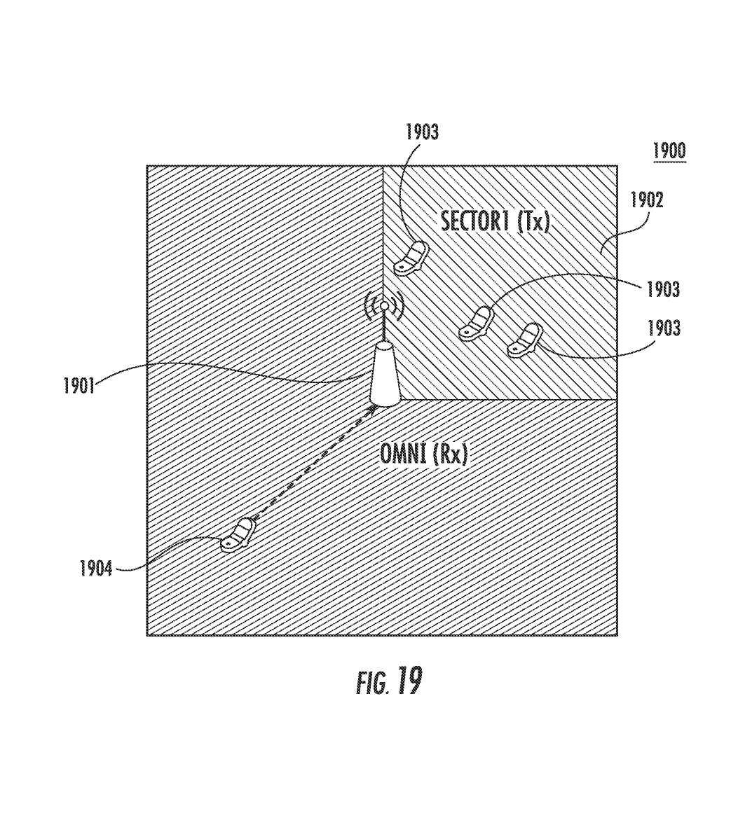

FIG. 19 shows an example 1900 in which the non-restricted STAs may be able to communicate with the AP during all sector intervals. In this example omni reception by AP 1901 may be permitted during sector transmission. STA 1904 is able to transmit to AP 1901 while sectorized transmission and reception occurs with STAs 1903a, 1903b, and 1903c in sector 1 1902. This omni reception may be (a) on always, (b) on only at the interval between sector-switching, (c) on between transmit opportunities within a sector duration, or (d) on at all distributed coordination function (DCF) interframe space (DIFS) intervals (i.e., when the medium is inactive during CSMA/CA multiple transmission). The network may schedule a single TBTT for an omni-directional beacon and may aggregate the sector announcement frame with this omni-directional beacon. Additional beacons for each sector may be eliminated. To enable access by a high-priority STA 1904, as shown in FIG. 19, reception for a defined interval may be based on omni reception as opposed to sectorized reception in IEEE802.11ah sectorization. The reception may switch back to sectorized reception if a STA in the sector acquires the channel. The specific operation may be one of the following: a) the DIFS interval on the switch between sectors may be based on omni reception; b) any DIFS interval between data transmission (even in a sector based transmission/reception) may be based on omni reception; or c) all reception may be based on omni reception.

In a dense carrier-grade network with a large number of APs and a large number of STAs, the BSSs may overlap and there may be scenarios where transmission from one sectorized AP to a STA may impact another overlapping AP/STA pair. During the uplink transmission of a STA at the edge of the BSS, and depending on the level of overlap, there may be severe interference in a neighboring BSS even with the use of sectorization. This interference may limit downlink transmission in the neighboring BSS due to the clear channel assessment mechanism (RTS/CTS or CCA based clear channel assessment) detecting control frames or energy from the transmitting STA. Alternatively or additionally, the interference from the STA at the edge of the BSS may limit uplink reception in the neighboring BSS due to the interference received at the neighboring AP. Procedures that incorporate beamforming with sectorization and/or group STAs based on their network location may be used to solve this problem.

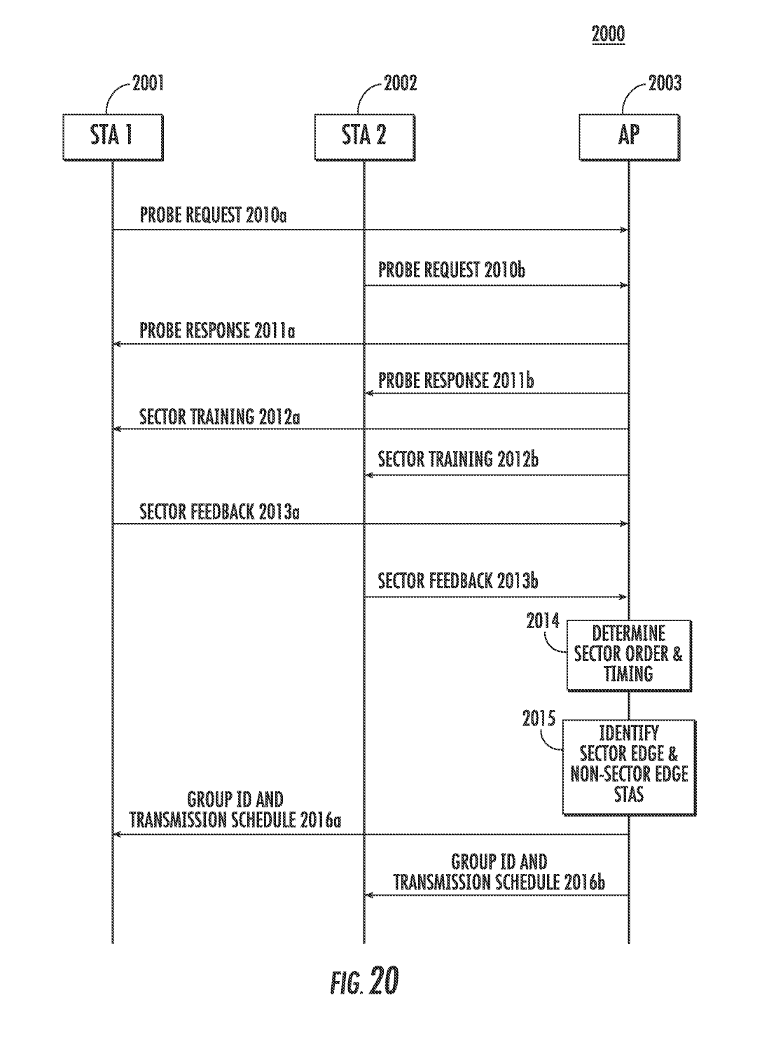

FIGS. 20-23 are examples of Type 0 sectorization with fractional CSMA in dense cell deployments for carrier grade networks with overlapping BSSs in accordance with yet another embodiment, which may be used in combination with any of the other embodiments described herein. A carrier grade network may have a large number of STAs and a large number of APs, with overlap in the BSSs. The sectors schedules may be coordinated to ensure that they point in different directions to limit interference. However, even with the coordinated sector transmission, BSS edge transmissions in one BSS may negatively impact the APs in neighboring BSSs due to the dense AP deployment. The following may limit the effect of interference in the overlapping BSS scenario: a) sector transmission coordinated between adjacent APs, b) sub-grouping of STAs in each sector to sector-edge and sector-center STAs, c) additional TPC to limit the amount of interference, and d) additional coordination between BSSs to ensure that BSS edge STAs do not transmit at the same time.

FIG. 20 is a call flow diagram of a procedure 2000 for implementing Type 0 sectorization with fractional CSMA in dense cell deployments for carrier grade networks with overlapping BSSs. When a STA joins a network it may indicate that it supports sectorization and fractional CSMA transmission during the sector capabilities exchange with its BSS. In the example of FIG. 20, two STAs and one AP are used, but this procedure may be expanded to any number of STAs or APs. STA 1 2001 and STA 2 2002 may transmit probe requests 2010a and 2010b to the network/AP 2003. AP 2003 may transmit probe responses 2011a and 2011b with the sectorization and fractional CSMA capability set to true. AP 2003 may initiate the sector training operation by transmitting sector training messages 2012a and 2012b to identify the number of STAs and their corresponding sector IDs. This may be achieved using a procedure similar to that disclosed above for coordinated, beamformed, and sectorized transmission using explicit and implicit channel state feedback in a WLAN sectorized network.

STA 1 2001 and STA 2 2002 may continually feed back information by transmitting feedback messages 2013a and 2013b with each data transmission to provide the AP information it may need for sector order and timing. STA 1 2001 and STA 2 2002 may add information to this sector ID feedback regarding its buffer delay, current contention window value, and traffic priority to assist the AP in setting up the sector order and timing.

AP 2003 may then decide the sector order and timing 2014, which may be decided as a function of STA parameters such as the number of STAs in the sector, the contention window values of each STA, the traffic buffer delay, and the traffic priority, among other metrics. In addition, the order may also be a function of other APs based on multi-AP coordination to reduce interference. Also, upon receiving the sector ID information, each AP may identify 2015 the sector-edge STAs and non-sector-edge (or sector center) STAs under its control. Sector-edge group and non-sector-edge group STAs may be identified using a variety of different techniques such as path loss, geographic location, STA assisted and/or genie aided. AP 2003 may then transmit a group identification assignment and a transmission schedule 2016a and 2016b to STA 1 2001 and STA 2 2002 based on the sector-edge and non-sector-edge identification and the sector order and timing.

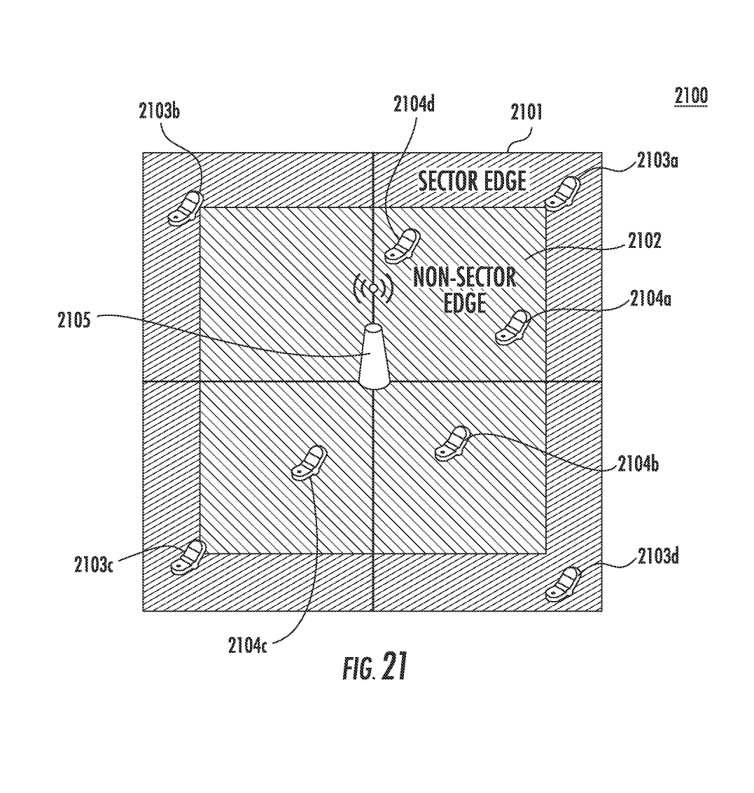

FIG. 21 shows an example system 2100 using Type 0 sectorization with fractional CSMA showing sector edge and non-sector-edge STAs. In the example of FIG. 21, AP 2105 coordinates transmissions among STAs 2103a, 2103b, 2103c, and 2103d in the sector edge 2101 and STAs 2104a, 2104b, 2104c, and 2104d in the non-sector-edge 2102. As shown in FIG. 21, the sector-edge group may include STAs located at an edge of the coverage area associated with the AP, and the non-sector-edge group may include STAs located at a center of the coverage area associated with the AP. In this example, the sector-edge and non-sector-edge STAs transmit and receive data packets to and from the AP based on their group identification assignments and/or the transmission schedule.

Multiple APs and sectors may coordinate to allow access of each to the pool of STAs performing CSMA/CA based on the BSS index. For example, in a simple scenario in which the number of sectors, their ordering, and their timing are identical for all STAs, the following procedure may be used. For a specific sector in AP1, the first half of the sector duration may allow both sector-edge and sector-center STAs to transmit while the second half may allow only sector-center STAs to transmit. For the same sector in AP2 (adjacent to AP1 and impacted by AP1's sector-edge STAs), the first half of the sector duration may allow only sector-center STAs to transmit while the second half may allow both sector-center and sector-edge STAs to transmit. Note that the coordination may allow some level of overlap for partial orthogonality. The transmit power level may be adjusted based on the group in the active CSMA/CA pool. If only sector-center STAs only are in the pool, then the maximum transmit power may be limited to the “worst” STA in the limited group, i.e., the STA that requires the maximum transmit power in that group. This maximum transmit power may be used for both data and control frames. If all STAs are in the pool, then the maximum transmit power may be limited to the “worst” STA in the BSS, i.e., the STA that requires the maximum transmit power in the BSS. In this manner, the interference mitigation and large STA management benefits of sectorized transmission may be gained over a large part of the network and the effect of the overlapping BSSs may be mitigated.

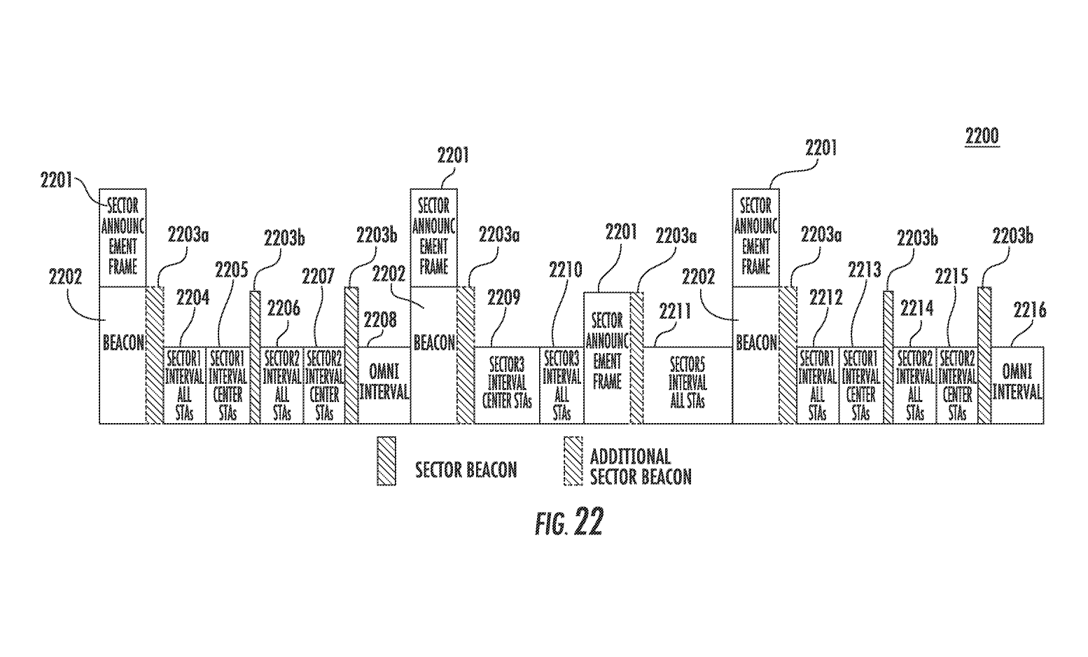

FIG. 22 is a diagram of an example using Type 0 sectorization with fractional CSMA showing sector edge and non-sector-edge STAs for HEW 2200. In the example of FIG. 22, a sector announcement frame 2201 incorporated with beacon 2202 may be first transmitted. This may then be followed by a sector transmission interval, which for example may be in the following order: sector 1 interval all STAs 2204, sector 1 interval center STAs 2205, sector 2 interval all STAs 2206, sector 2 interval center STAs 2207, omni interval 2208, sector 3 interval center STAs 2209, sector 3 interval all STAs 2210, sector 5 interval all STAs 2211, sector 1 interval all STAs 2212, sector 1 interval center STAs 2213, sector 2 interval all STAs 2214, sector 2 interval center STAs 2215, and omni interval 2216. Also, following the sector announcement frame 2201, additional sector beacons 2203a may be transmitted. As shown in the example of FIG. 22, sector beacons 2203b may also be transmitted in between sector transmission intervals.

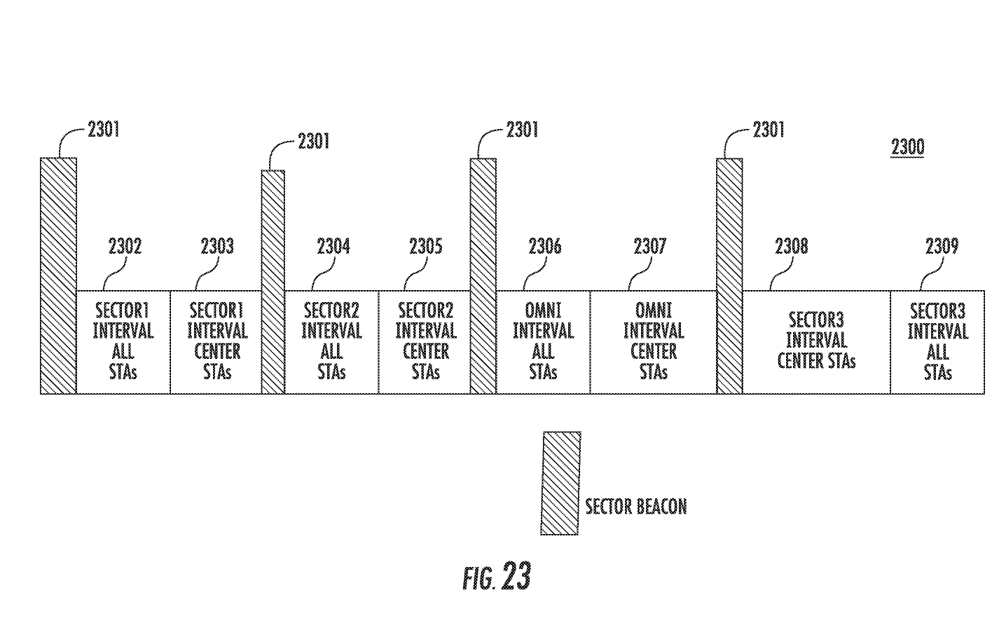

FIG. 23 is a diagram of an example using Type 0 sectorization with fractional CSMA showing sector edge and non-sector-edge STAs for IEEE 802.11ah+2300. In the example of FIG. 23, following each sector beacon 2301, there is a sector transmission interval which may be in the following order: sector 1 interval all STAs 2302, sector 1 interval center STAs 2303, sector 2 interval all STAs 2304, sector 2 interval center STAs 2305, omni interval all STAs 2306, omni interval center STAs 2307, sector 3 interval center STAs 2308, and sector 3 interval all STAs 2309.

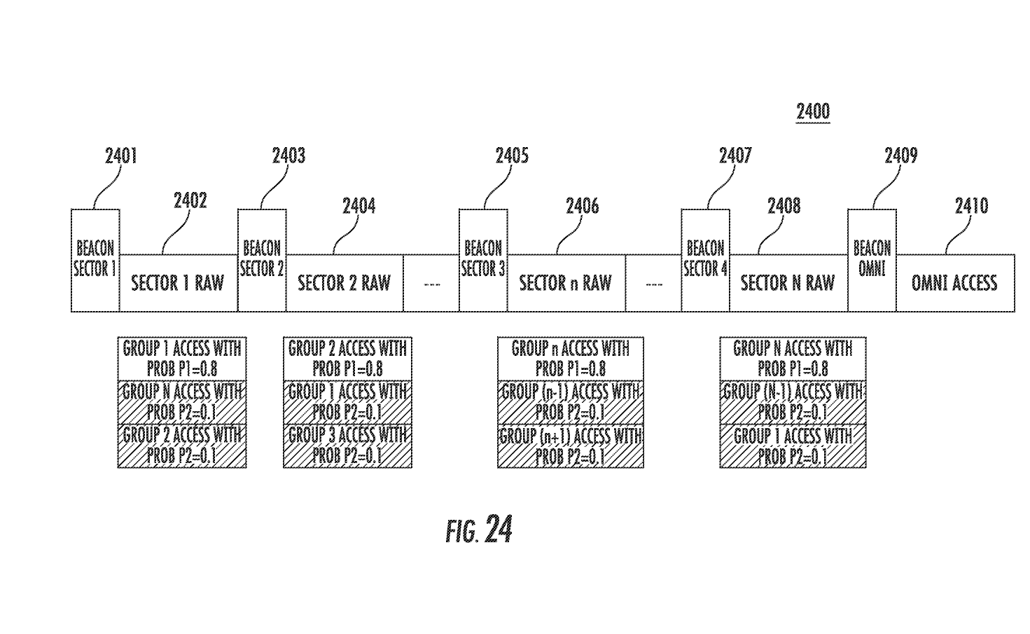

FIG. 24 shows an example system 2400 using Type 0 sectorization with fractional CSMA across adjacent sectors in accordance with yet another embodiment, which may be used in combination with any of the other embodiments described herein. An AP with sectorization capability may serve STAs in up to N different sectors. The N different sectors may be overlapping or non-overlapping. Without loss of generality, non-overlapping sectors are considered herein. In the example of FIG. 24, STAs physically in sector 1 be given a group ID 1, STAs physically in sector 2 be given a group ID 2, . . . , and STAs physically in sector N be given a group ID N. It may be assumed that sectors with adjacent sector IDs (or group IDs) may be geographically adjacent as well. In other words, sector 1 may border sector 2 and sector N, sector 2 may border sector 1 and sector 3, and in general, sector n may border sector (n−1) and sector (n+1).

In the example of FIG. 24, the AP may first send out a beacon using sector 1 2401, followed by a restricted access window (RAW) 2402 in which users in sector 1 (which are given group ID 1) may access the channel with a higher probability. For example, group-1 users may access the channel with a smaller contention window. The nearby users in the adjacent sectors (which are given group ID 2 and N) may access the channel with a lower probability. For example, group-2 users and group-N users may access the channel with a larger contention window. The other users in non-adjacent sectors may not access the channel.

The AP may continue the sectorization operation by sweeping to the Nth sector: the AP may send out a beacon using sector 2 2403, a RAW for sector 2 2404, a beacon using sector 3 2405, a RAW for sector n 2406, a beacon for sector 4 2407, and a RAW for sector N 2408. In general, when sector n is the primary sector, users in sector n (which are given group ID n) may access the channel with a higher probability. For example, group-n users may access the channel with a smaller contention window. The nearby users in the adjacent sectors (which are given group ID n−1 and n+1) may access the channel with a lower probability. For example, group-(n−1) users and group-(n+1) users may access the channel with a larger contention window. The other users in non-adjacent sectors may not access the channel. Finally, the AP may set up an omni access window 2410 following sending out an omni beacon 2409, wherein all STAs, irrespective of their group IDs or sector IDs, may access the channel.

The following embodiment considers sectorization training that may help STAs determine the best sectors for communication with the AP. In the sector discovery procedure, an NDP transmission may be required for each sector with the position of the training NDP frames corresponding to the sector IDs of the sectorized beams in ascending order starting from zero. This implies that there may be a fixed overhead for sector training. With current 802.11ah specification, sectorization training and feedback may be implemented in a unicast way, i.e., the AP may perform the sectorization training for a specified STA and the STA may feedback the sector ID. Alternatively, the AP may schedule sector sounding for multiple STAs using a restricted access window (RAW) in a beacon interval using the RAW parameter set element. STAs may listen to the sector training for the entire RAW. When multiple STAs report their sector ID feedback frames to the AP, sector ID feedback frames may be protected by the sector report RAW indicated in the beacon to avoid contentions with others. The overhead of sectorization feedback may be reduced by performing sector ID feedback with certain signal to noise ratio (SNR) threshold/requirements when initiated with by the STA or the AP.

In STA initiated SNR driven sectorization training and feedback, STAs may request sectorization training and/or feedback when necessary. In the following conditions, STAs may request sectorization training/feedback.

Under a first condition, STAs may measure the SNR on the operating sector. If the measured SNR is below certain SNR threshold, the STA may initiate the sector training, or the STA may check for the second condition. The SNR threshold may be defined in a standard or by the AP and broadcasted in the beacon frames.

Under a second condition, STAs may monitor the sounding RAW transmitted from the AP to multiple STAs. STAs may check the SNR of the operating sector and the maximum SNR of all the sectors. If the two SNRs are different, then STAs may calculate SNR_delta which may be defined as

SNR_delta=max(SNR)−SNR_operating_sector. Equation (1)

If SNR_delta is larger than the SNR_delta_threshold, the STA may feedback the sector ID with maximum SNR. The SNR_delta_threshold may be defined in the standard or by the AP and broadcasted in the Beacon frames.

In AP Initiated SNR driven sectorization training and feedback, the AP may schedule sector sounding for multiple STAs by using a sounding RAW. With SNR driven sectorization training, the sounding RAW may not be defined as traditional RAW with an AID. Instead, the AP may ask STAs which satisfy certain conditions to feed back the sector ID.

Under a first condition, the AP may announce a SNR interval/threshold. STAs may record the maximum SNR among all the sectors. If the maximum SNR falls in the SNR interval or smaller than the SNR threshold, the STA may perform Sector ID feedback.

Under a second condition, the AP may announce a SNR_delta interval/threshold. The SNR_delta may be calculated in the same way as Equation (1). If the SNR_delta falls in the SNR interval or is smaller than the SNR threshold, the STA may perform Sector ID feedback.

In this way, the AP may control the number of STAs which may perform sector ID feedback by adjusting SNR interval/threshold and/or SNR_delta interval/threshold. The AP may ask the STAs to check to see whether one or both of the conditions are met.

Although the solutions described herein consider 802.11 specific protocols, it is understood that the solutions described herein are not restricted to this scenario and are applicable to other wireless systems as well.

Although the solutions in this document have been described for uplink operation, the methods and procedures may also applied to downlink operation.

Although short interframe space (SIFS) is used to indicate various inter frame spacing in the examples of the designs and procedures, all other inter frame spacing such as reduced interframe space (RIFS) or other agreed time interval could be applied in the same solutions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a IEEE 802.11 station (STA), the method comprising:
transmitting a feedback message to an access point (AP), wherein the feedback message is associated with a sector of the AP of a plurality of sectors of the AP wherein the plurality of sectors of the AP are each associated with a respective directional portion of a coverage area of the AP and wherein the feedback message includes a buffer delay, a contention window, and a traffic priority;
receiving a group identification assignment from the AP, wherein the group identification assignment identifies the STA in either a sector-edge group that includes STAs located at an edge of the respective directional portion of the coverage area of the AP or a non-sector-edge group that includes STAs located at a center of the respective directional portion of the coverage area of the AP based on the transmitted feedback message;
receiving a transmission schedule from the AP, wherein the transmission schedule includes a first interval for transmission by STAs assigned to the sector-edge group and a second interval for transmission by STAs assigned to the non-sector-edge group; and
transmitting data to the AP based on the received transmission schedule, wherein the transmitting is at a power level adjusted based on whether the STA is assigned to the sector-edge group or the non-sector-edge group.

2. The method of claim 1, wherein the power level is limited to another STA in a same group identification assignment that requires a maximum transmit power.

3. The method of claim 1, wherein the power level is limited to another STA in a same basic service set (BSS) that requires a maximum transmit power.

4. The method of claim 1, wherein the feedback message is associated with a sub-sector of the AP.

5. The method of claim 1, wherein the transmission schedule is coordinated with another AP.

6. The method of claim 1, wherein the group identification assignment is coordinated with another AP.

7. The method of claim 1, further comprising:
receiving sector training messages from the AP; and
transmitting feedback information associated with a sector identification to the AP.

8. A IEEE 802.11 station (STA), the STA comprising:
a transmitter configured to transmit a feedback message to an access point (AP), wherein the feedback message is associated with a sector of the AP of a plurality of sectors of the AP wherein the plurality of sectors of the AP are each associated with a respective directional portion of a coverage area of the AP and wherein the feedback message includes a buffer delay, a contention window, and a traffic priority;
a receiver configured to receive a group identification assignment from the AP, wherein the group identification assignment identifies the STA in either a sector-edge group that includes STAs located at an edge of the respective directional portion of the coverage area of the AP or a non-sector-edge group that includes STAs located at a center of the respective directional portion of the coverage area of the AP based on the transmitted feedback message;
the receiver further configured to receive a transmission schedule from the AP, wherein the transmission schedule includes a first interval for transmission by STAs assigned to the sector-edge group and a second interval for transmission by STAs assigned to the non-sector-edge group; and
the transmitter further configured to transmit data to the AP based on the received transmission schedule, wherein the transmitting is at a power level adjusted based on whether the STA is assigned to the sector-edge group or the non-sector-edge group.

9. The STA of claim 8, wherein the power level is limited to another STA in a same group identification assignment that requires a maximum transmit power.

10. The STA of claim 8, wherein the power level is limited to another STA in a same basic service set (BSS) that requires a maximum transmit power.

11. The STA of claim 8, wherein the feedback message is associated with a sub-sector of the AP.

12. The STA of claim 8, wherein the transmission schedule is coordinated with another AP.

13. The STA of claim 8, wherein the group identification assignment is coordinated with another AP.

14. The STA of claim 8, further comprising:
the receiver further configured to receive sector training messages from the AP; and
the transmitter further configured to transmit feedback information associated with a sector identification to the AP.

15. A method for use in an access point (AP), the method comprising:
receiving a feedback message from an IEEE 802.11 station (STA), wherein the feedback message is associated with a sector of the AP of a plurality of sectors of the AP wherein the plurality of sectors of the AP are each associated with a respective directional portion of a coverage area of the AP;
determining a group identification assignment for the STA, wherein the group identification assignment identifies the STA in either a sector-edge group that includes STAs located at an edge of the respective directional portion of the coverage area of the AP or a non-sector-edge group that includes STAs located at a center of the respective directional portion of the coverage area of the AP based on the received feedback message;
determining a transmission schedule to the STA, wherein the transmission schedule includes a first interval for transmission by STAs assigned to the sector-edge group and a second interval for transmission by STAs assigned to the non-sector-edge group;
transmitting the determined group identification assignment and determined transmission schedule to the STA; and
receiving data from the STA at an interval based on the transmission schedule.

16. The method of claim 15, wherein the data is received from the STA transmitting at a power level adjusted based on whether the STA is assigned to the sector-edge group or the non-sector-edge group.

17. The method of claim 16, wherein the power level is limited to the STA in a same group identification assignment that requires a maximum transmit power.

18. The method of claim 16, wherein the power level is limited to the STA in a same basic service set (BSS) that requires a maximum transmit power.

19. The method of claim 15, wherein the feedback message includes a buffer delay, a contention window, and a traffic priority.

20. The method of claim 15, further comprising:
transmitting sector training messages to the STA; and
receiving feedback information associated with a sector identification from the STA.
